(19) United States
(12) Patent Application Publication
(10) Pub. No.: US 2019/0176173 A1
(43) Pub. Date: Jun. 13, 2019

(54) SHOWER HEAD PRODUCING A SUSPENSION OF WATER DROPLETS IN AIR

(71) Applicant: KELDA SHOWERS LIMITED, Soulthampton Hampshire (GB)

(72) Inventors: Christopher HONEYANDS, Somerset (GB); Peter James HONEYANDS, Martock Somerset (GB)

(21) Appl. No.: 16/327,738

(22) PCT Filed: Aug. 15, 2017
(86) PCT No.: PCT/GB2017/052394

§ 371 Date: Feb. 22, 2019

(30) Foreign Application Priority Data
Aug. 22, 2016 (GB) 1614340.6

(51) Int. Cl. B05B 7/04; B05B 1/18

(52) U.S. Cl. CPC B05B 7/0441; B05B 7/0087; B05B 1/18

(57) ABSTRACT

A shower head 10, 10′ comprises one or more droplet formation chambers 50, each chamber being supplied with water and pressurised air which divides the water into droplets suspended in the airflow. In one aspect, the geometric parameters of the droplet formation chamber are selected to maintain a balance between primary and secondary droplet formation modes wherein a proportion of the primary droplets formed within the chamber are stripped out of the airflow by impact with the chamber walls and re-entrained as secondary droplets formed by thin film disintegration. In another aspect, the air inlet 40 into the droplet formation chamber is provided with guide surfaces 45 which maintain a parallel axial airflow through the chamber.

This invention relates to showers for use in bathing, and in particular to shower heads for mixing air and water to form a suspension of water droplets distributed in the airflow.

Traditionally, a shower head for use in bathing has comprised a finely perforated plate, known as a rose, with a water inlet for supplying water to a plenum chamber behind the plate so as to finely divide the water as it flows through the numerous perforations.

In recent years it has become common to mix air into the water, either by drawing in ambient air via an ejector pump or other Venturi based device or by supplying pressurised air from an air pump, so that water is emitted from the shower head as a continuous liquid phase containing numerous air bubbles to form a so-called foam or foaming shower.

Less commonly, it is known to divide the water inside a droplet formation chamber within the showerhead to form individual droplets suspended in a continuous gaseous phase (referred to herein as a “water-in-air” showerhead). The droplets formed in the droplet formation chamber are carried intact out of the showerhead in suspension in a flow of air which is much larger in volume than the water flow. This dramatically reduces the amount of water required to wash the body while distributing the relatively small volume of water over the user's body to deliver a sensory shower experience comparable with that of a conventional shower using more water.

Water-in-air showerheads are exemplified by WO2009/056887 A1, WO2012/110790 A1, and WO 2012/175966 A1 to the present applicant.

Other apparatuses for generating a suspension of water droplets in air are disclosed, for example by US2002/0000477 A1, JP H09-262512, and U.S. Pat. No. 3,965,494.

It should be noted that water-in-air showerheads are distinguished over nozzles (often referred to as “atomizing nozzles”) for generating a mist or fog, e.g. for horticultural or other purposes, by their relatively much larger droplet size. An atomizing nozzle typically produces droplets in a size range up to about 50 microns diameter. In order for a water-in-air showerhead to deliver an acceptable shower experience for the user, it is important that the water droplets are big enough to retain both heat and kinetic energy from the point of exit from the showerhead until the point of impact with the user's body. This requires droplets of at least about 500 microns diameter, around an order of magnitude larger than those produced by an atomizing nozzle, and moreover requires that the droplets are able to exit the shower head intact.

The density of nerve endings in the human body is such that, if the droplets are sufficiently large, numerous, and evenly distributed, then their individual impacts in combination with the kinetic energy of the larger volume airflow are experienced by the user as a sensation comparable with the relatively larger volume of water delivered as a continuous aqueous phase from a conventional showerhead, while the impact forces of the droplets are sufficient to effectively cleanse the skin. If however the droplets are too small then all or most of their energy will be lost after they exit the nozzle and before reaching the user, so that the combined flow of air and water is experienced as a cool, clammy mist.

In a water-in-air showerhead, the required droplet size is achieved by mixing moving streams of air and water so that the water is broken up by the airflow to form droplets inside a droplet formation chamber, and then ejecting intact the droplets so formed from the outlet of the chamber in suspension in the airflow to form the spray. Notably, the droplets are formed by the interaction between the moving streams of air and water rather than by impacting the water against a surface. Water-in-air shower heads therefore do not include a conventional rose at the outlet, which would cause the individual water droplets to disintegrate on impact.

In contrast, in an atomizing nozzle the water may either be introduced into a high velocity airstream or impacted at high velocity against a surface, or a combination of both techniques may be used, to produce the much smaller droplet size range required to form a fog or mist.

Although it is known that a water-in-air showerhead should produce a different droplet size range from, e.g. an atomizing nozzle, it has been found difficult in practice to achieve a droplet size distribution which delivers a satisfactory shower experience at a low water flow rate, for example, of about 5 l/m (litres per minute).

A more particular concern in any technology for generating water droplets, particularly from a warm water source, is the potential for contamination by legionella and similar organisms which enter the body via the respiratory tract. Where the user is exposed to a high concentration of suspended droplets within the confines of a shower enclosure, a droplet size below 10 microns diameter and particularly from 1 micron to 5 microns diameter will be particularly of concern since inhaled droplets in this size range are deposited deep in the lungs, whereas larger droplets are deposited in the oropharyngeal region and so represent less of a hazard. (N. R. Labiris and M. B. Dolovich, “Pulmonary drug delivery. Part 1: Physiological factors affecting therapeutic effectiveness of aerosollized medications,” British Journal of Clinical Pharmacology, vol. 56, pp. 588-599, Dec. 2003.) Droplets in the hazardous, sub-10 micron and even sub-1 micron size range are observed in practice to be formed by the detachment and subsequent disintegration in air of a thin film of water which forms on the surface of a conventional showerhead in use.

Another problem more specific to water-in-air showers as observed by the present applicant is that the subjective shower experience of the average user is not only tactile but also visual. Although in theory the principal advantage of water-in-air showers is their very low water consumption, in practice the lower limit for water flow rate is found to be limited by the experiential demands of the average user, not only for a sufficient aggregate amount of heat and kinetic energy to be delivered by the droplets, but also for the spray of water droplets to have a visual appearance of sufficient density to mimic the appearance of the more voluminous water flow from a conventional showerhead. If the visual element is lacking then the tactile experience is likely to be perceived as less satisfactory. For this reason the water flow rate may need to be increased somewhat above what otherwise might be the technically feasible lower limit.

In light of all these problems, the present invention sets out to improve the droplet generation performance of a water-in-air showerhead so as to provide a more satisfactory shower experience when the showerhead is used at a relatively low water flow rate.

Accordingly the invention provides a shower head and shower apparatus as defined in the claims.

The novel shower head may be incorporated into a shower apparatus including a pressurised air supply means and a water supply means, and includes at least one droplet generator, the droplet generator including a water inlet, an air inlet, and a droplet formation chamber. The droplet formation chamber defines a chamber axis Y extending in a flow direction F and comprising in series arrangement along the chamber axis in the flow direction: an inlet region, a throat downstream of the inlet region, a divergent region downstream of the throat, a convergent region downstream of the divergent region, and an outlet at a downstream end of the convergent region. The convergent region is defined by a wall which surrounds the chamber axis upstream of an outlet plane P3 normal to the chamber axis Y at the outlet. The water inlet and air inlet both open into the inlet region. The air inlet extends around the chamber axis and comprises at least one air inlet passage defining a mean airflow path.

The water inlet and air inlet are arranged so that in use, air flowing from the air inlet converges towards water flowing from the water inlet to form droplets of water suspended in air within the droplet formation chamber, with the outlet being arranged to deliver these droplets intact from the shower head as a spray of droplets in which a user may bathe.

The droplet formation chamber has:—
an axial length L1 from an upstream end of the divergent region at the throat to the outlet plane P3;
in a plane P1 normal to the chamber axis at the throat, a section area S1 corresponding to a nominal circle C1 of equal area and diameter D1 centred on the chamber axis;
in a plane P2 normal to the chamber axis at a downstream end of the divergent region, a section area S2 corresponding to a nominal circle C2 of equal area and diameter D2 centred on the chamber axis; and
in the outlet plane P3, a section area S3 corresponding to a nominal circle C3 of equal area and diameter D3 centred on the chamber axis.

The divergent region has an axial length L2 and defines in a plane containing the chamber axis a divergence angle Ad between the chamber axis and either of a pair of nominal straight lines extending from C1 to C2 on opposite sides of the chamber axis Y.

The convergent region has an axial length L3 and defines in a plane containing the chamber axis a convergence angle Ac between the chamber axis and either of a pair of nominal straight lines extending from C2 to C3 on opposite sides of the chamber axis Y.

In a first aspect of the invention, the air inlet passage opens into the inlet region at an air inlet opening and is arranged so that, when considered in a plane containing the chamber axis, a straight line extending the mean airflow path at the air inlet opening intersects the chamber axis at an impingement angle Ai in a range from 15°-45°.

The geometric parameters of the chamber are further selected so that the ratio L1:S1 is in the range from 2.5:1 to 6.4:1; S2 is not greater than 2.3·S1; the ratio L2:L3 is in the range from 0.6:1.4 to 1.4:0.6; and the divergence angle Ad is in the range from 2.5° to 15°.

Although not bound by theory, the invention recognises that in use, the water droplets emitted from the shower head are formed by two distinct mechanisms, referred to herein as primary and secondary modes of droplet formation.

The primary mode operates by the difference in velocity between the relatively faster airflow and relatively slower water flow entering the inlet region to divide the inflowing water stream into discrete, primary droplets suspended in the flowing through the droplet formation chamber. Although not fully understood, the primary mode is believed to operate by several mechanisms including, inter alia: attenuation of the water stream, chaotic disintegration, and surface friction leading to the detachment of ligatures formed by perturbations of the water stream at the air/water interface.

The secondary mode operates by thin film detachment. A proportion of the primary droplets are stripped out of the airflow by impact against the walls of the chamber, particularly in the convergent region, recombining to form a film of water on the chamber wall. The film of water then detaches at the outlet or downstream nozzle and is entrained again to form secondary droplets suspended in the air flowing away from the chamber.

When the geometric parameters of the chamber are selected to fall within the stated range, it is found that the droplet formation chamber may be operated with both primary and secondary modes in balance to produce an advantageous droplet size distribution as further explained below.

When configured as a whole-body shower, the novel shower head preferably incorporates at least three, more preferably from three to seven such droplet generators. The novel shower head combines primary and secondary modes of droplet formation to deliver a sensory (both tactile and visual) shower experience which is perceived by the user as comparable with a substantially greater water flow rate delivered from a conventional shower head. Surprisingly, although the novel chamber geometry is found in tests to result in a droplet size distribution with a smaller mean droplet size and a relatively long tail of much smaller droplets than conventional, aerating or non-aerating shower heads, it is found to generate a much smaller number of droplets in the potentially hazardous, sub-10 micron size range.

In a second aspect of the invention, the air inlet is divided by a plurality of guide surfaces to form a plurality of air inlet passages, and the air inlet passages converge towards the chamber axis substantially without revolution about the chamber axis, so that each air inlet passage defines a mean airflow path extending through the air inlet passage in a plane containing the chamber axis. The guide surfaces suppress vorticial flow about the chamber axis so that the air flows through the droplet formation chamber generally in parallel with the chamber axis Y.

It is known in the art to induce a swirling or vorticial flow in order to assist in mixing air and water within a shower head of either the conventional or “water-in-air” type. It has been found however, contrary to prior art teaching, that by suppressing vorticial flow around the chamber axis, the droplet formation chamber will tend to produce a better droplet size distribution. While the invention is not bound by theory, it is believed that the parallel flow results in a better balance between the primary and secondary droplet formation modes, whereas a strong vorticial flow will tend to cause the second mode (characterised by droplet recombination and thin film detachment) to predominate.

The guide surfaces in accordance with the second aspect of the invention may be applied to a water-in-air shower having droplet formation chambers of known type to improve the droplet size distribution, but are most effective when used with droplet formation chambers in accordance with the first aspect of the invention.

Preferably therefore, although each of the first and second aspects of the invention may be used without the other, both first and second aspects of the invention are combined for optimal performance. Such a combination is illustrated by the embodiment which will now be described, purely by way of example and without limitation to the scope of the claims, and with reference to the accompanying drawings, in which:

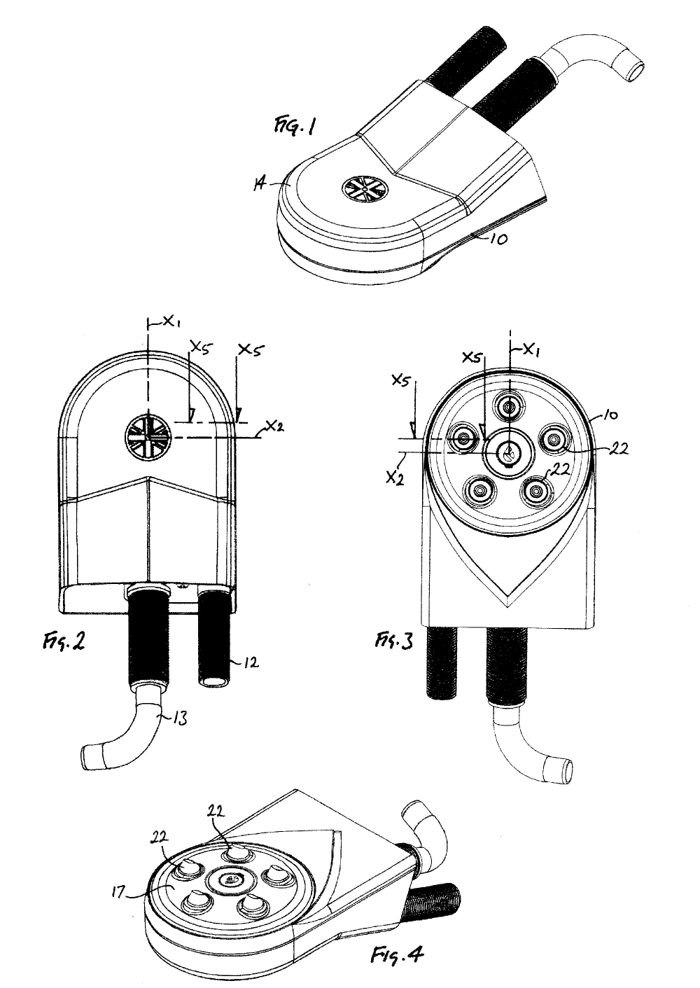

FIGS. 1-4 are top views (FIGS. 1 and 2) and bottom views (FIGS. 3 and 4) of a first shower head with five droplet generators and designed for installation in a fixed position in accordance with an embodiment of the invention;

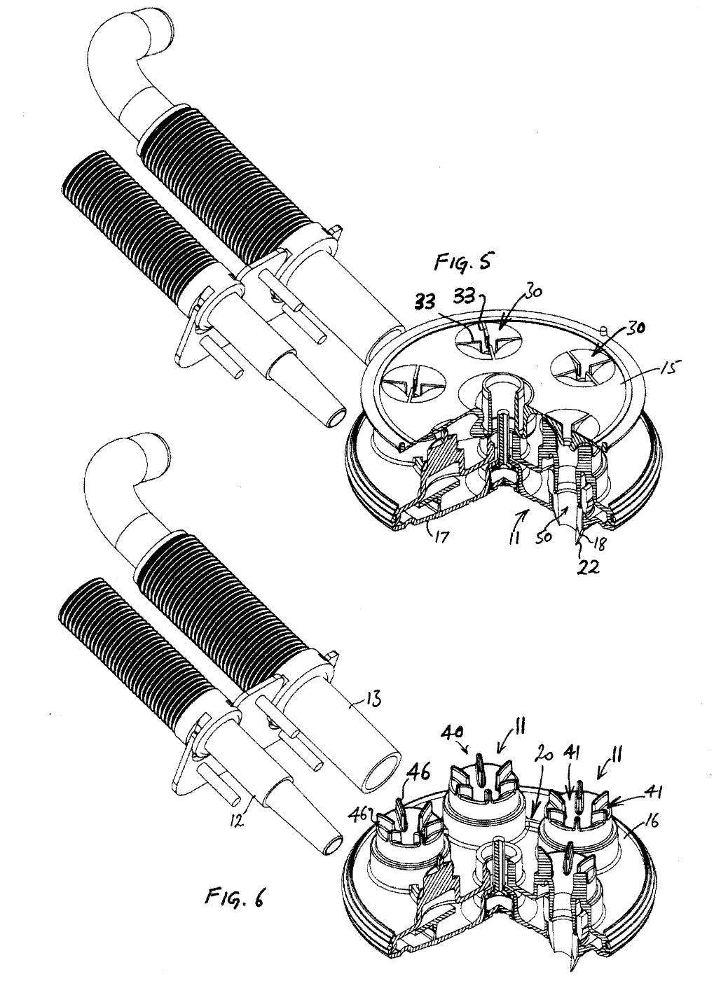

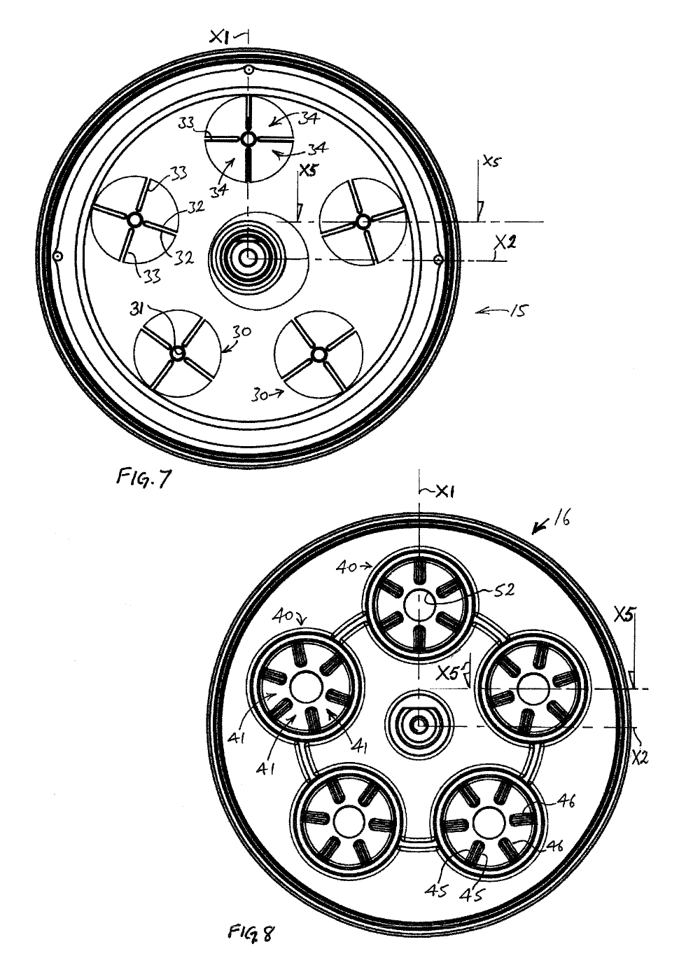

FIGS. 5 and 6 show the the first shower head sectioned at X1 and X2 and with its outer casing removed, wherein FIG. 5 shows the water distribution plate and in FIG. 6 the water distribution plate is removed to show the air distribution plate which lies beneath it;

FIGS. 7 and 8 are plan views respectively of the water distribution plate (FIG. 7) and the air distribution plate (FIG. 8);

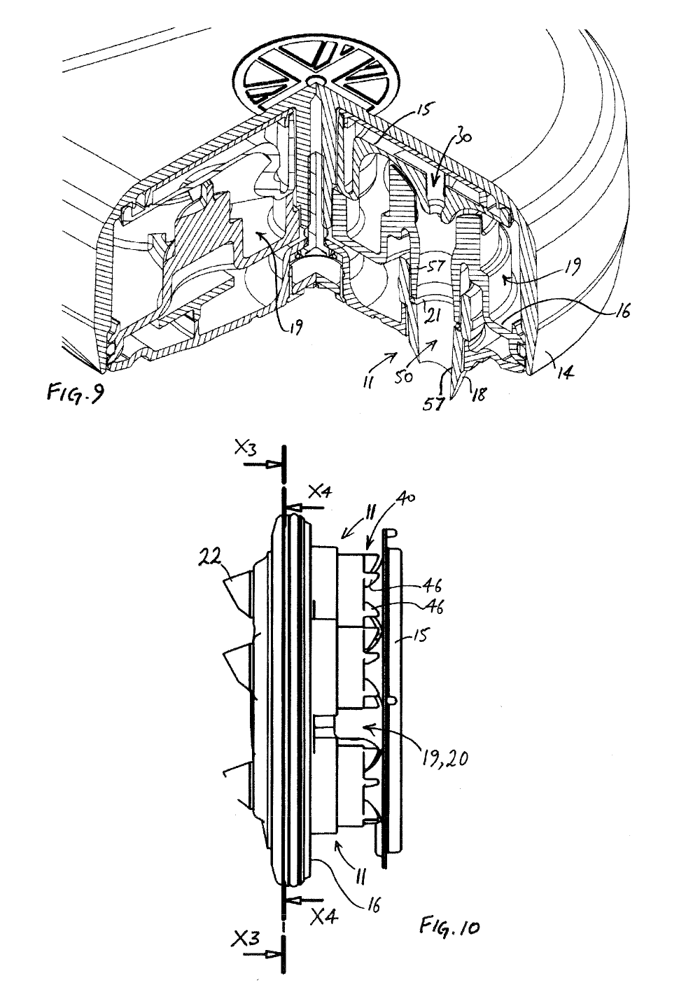

FIG. 9 shows the first shower head complete with its outer casing and sectioned at X1 and X2;

FIG. 10 is a side view of the first shower head with its outer casing removed;

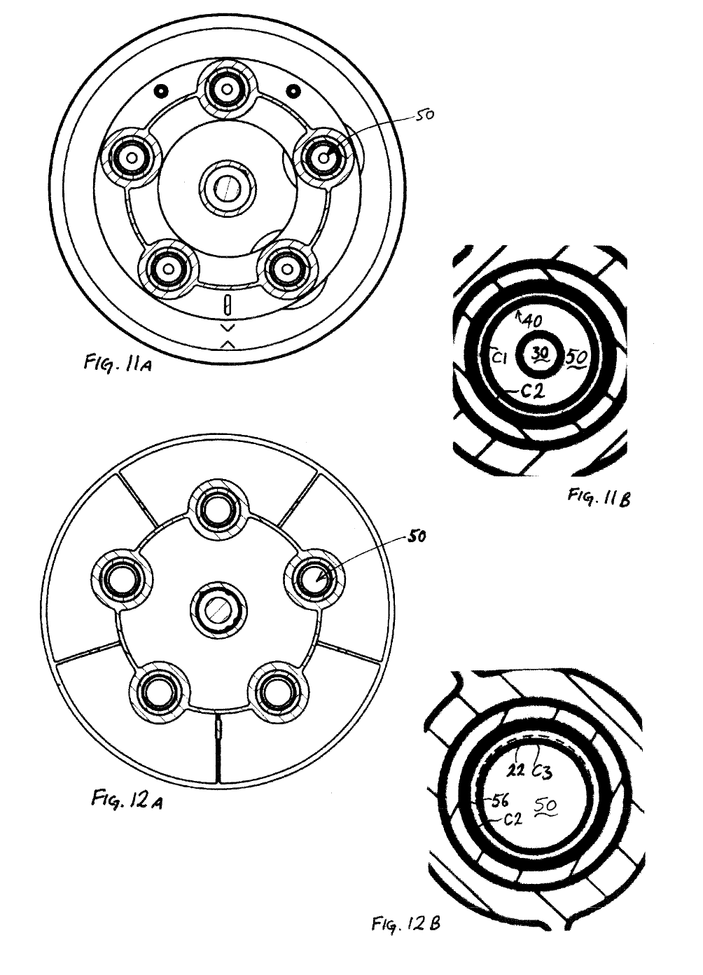

FIGS. 11A and 12A are sections through the first shower head respectively at X3 (FIG. 10) showing the upstream end of the droplet formation chambers (FIG. 11A), and at X4 (FIG. 10) showing the downstream end of the droplet formation chambers (FIG. 12A);

FIGS. 11B and 12B are enlarged views of one of the droplet formation chambers as shown respectively in FIGS. 11A and 12A;

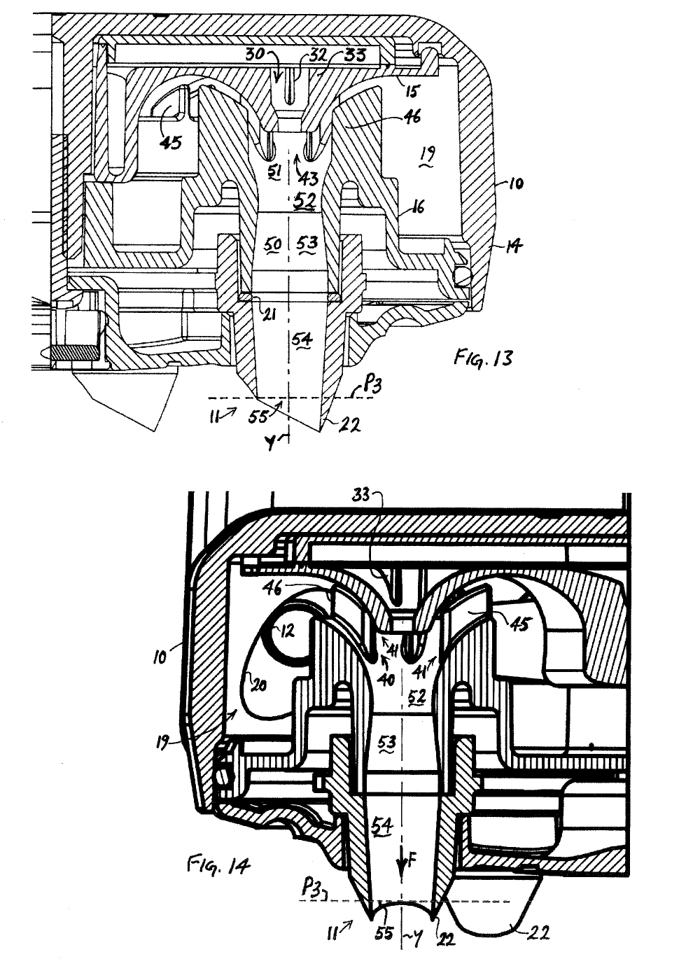

FIG. 13 is a section at the plane X1 containing the chamber axis, showing more clearly the droplet generator which appears in FIG. 9;

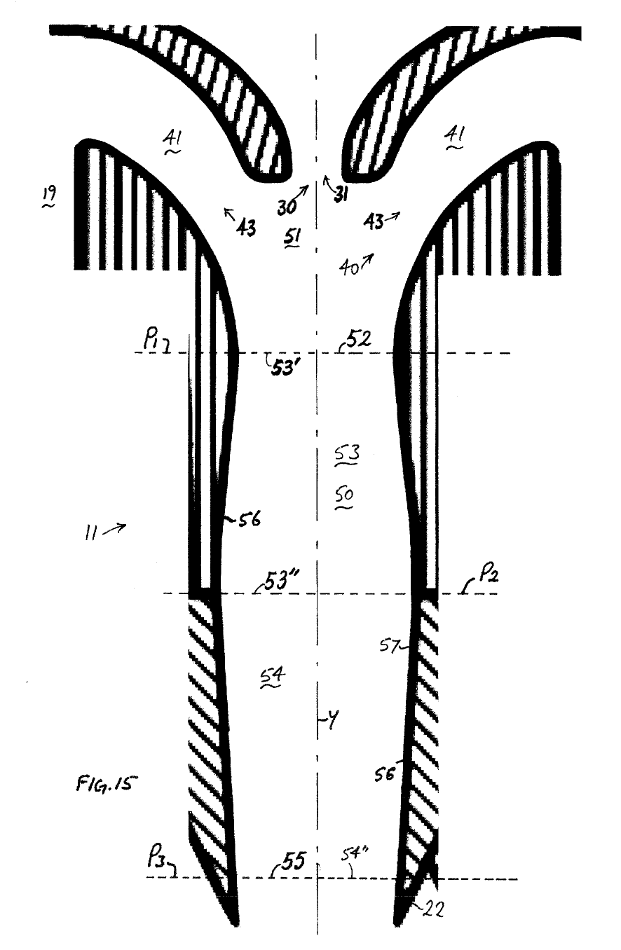

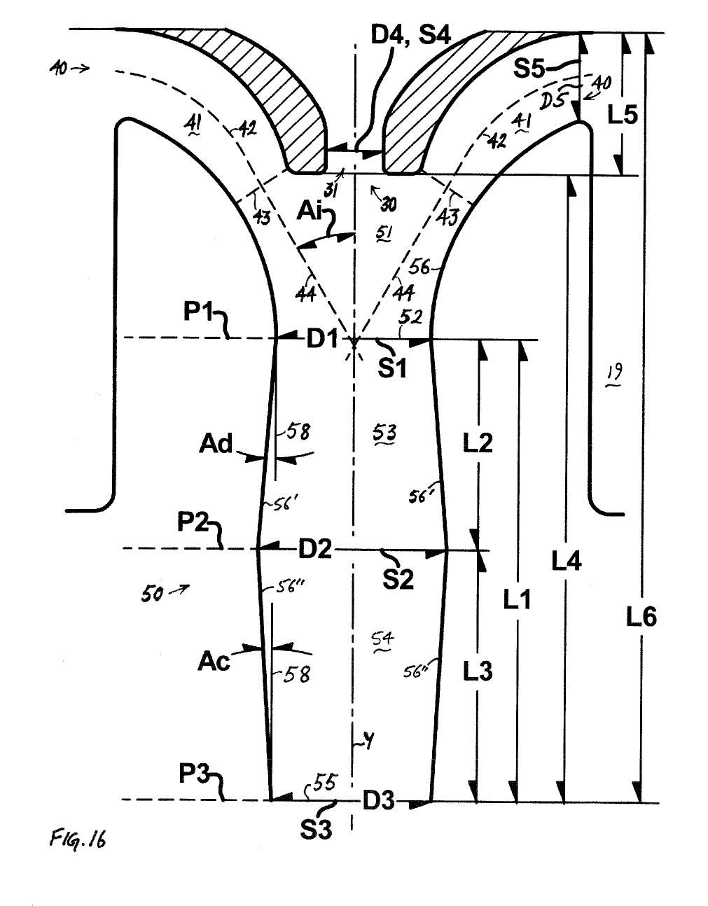

FIG. 14 is a section at the plane X5 containing the chamber axis through another one of the droplet generators, identical to that shown in FIG. 13 except in that the section is taken between the air and water guide vanes to better illustrate the internal shape of the droplet formation chamber, and in that a slightly different construction is shown in which the O-ring at the widest point of the chamber is omitted;

FIG. 15 is an enlarged and simplified view of the internal surfaces of the droplet formation chamber and air inlet passages of FIG. 14, with the air and water guide vanes and other detail removed to better show its internal shape;

FIG. 16 is another simplified view of the droplet formation chamber, corresponding to that of FIG. 15 and showing the mean airflow paths and other geometric parameters;

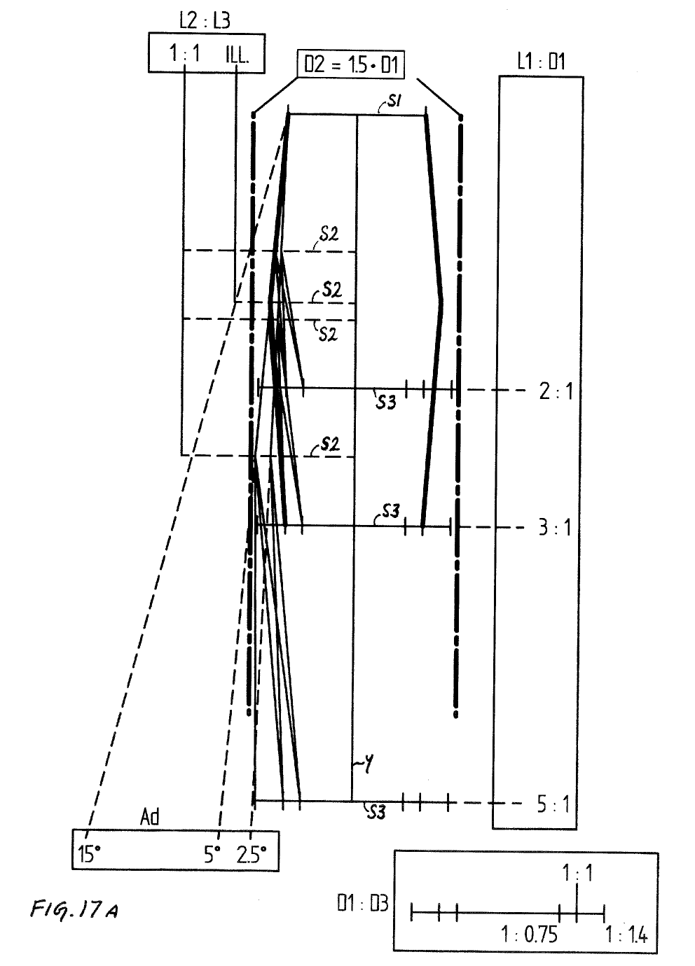

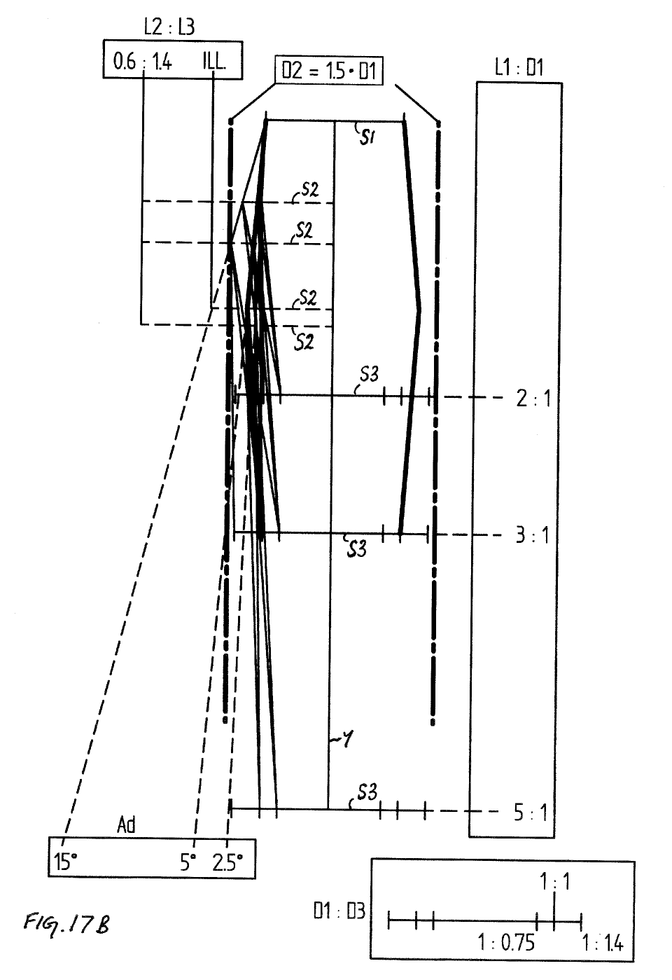

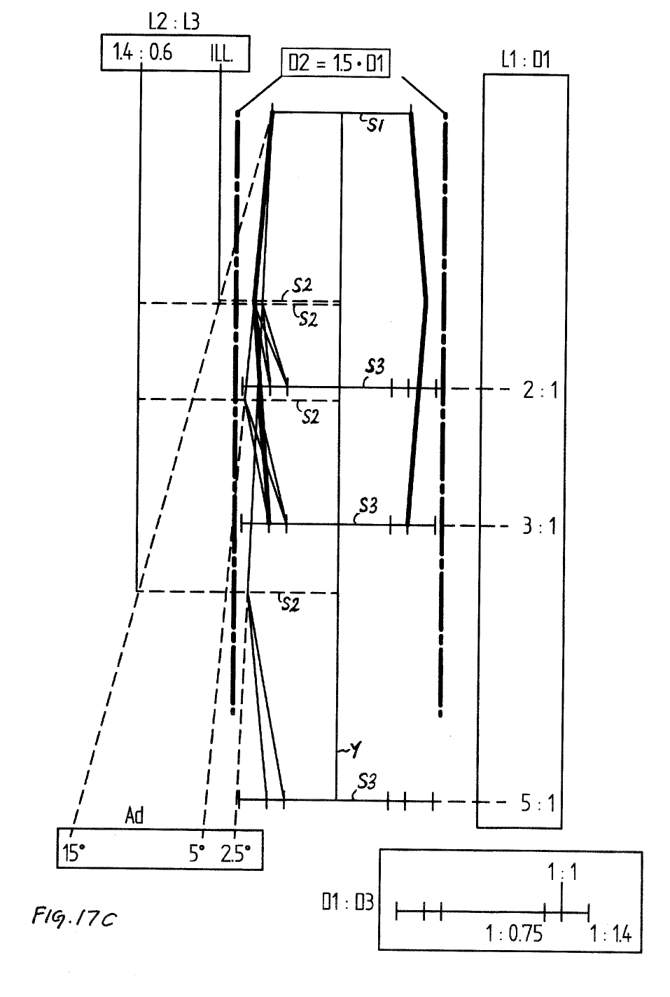

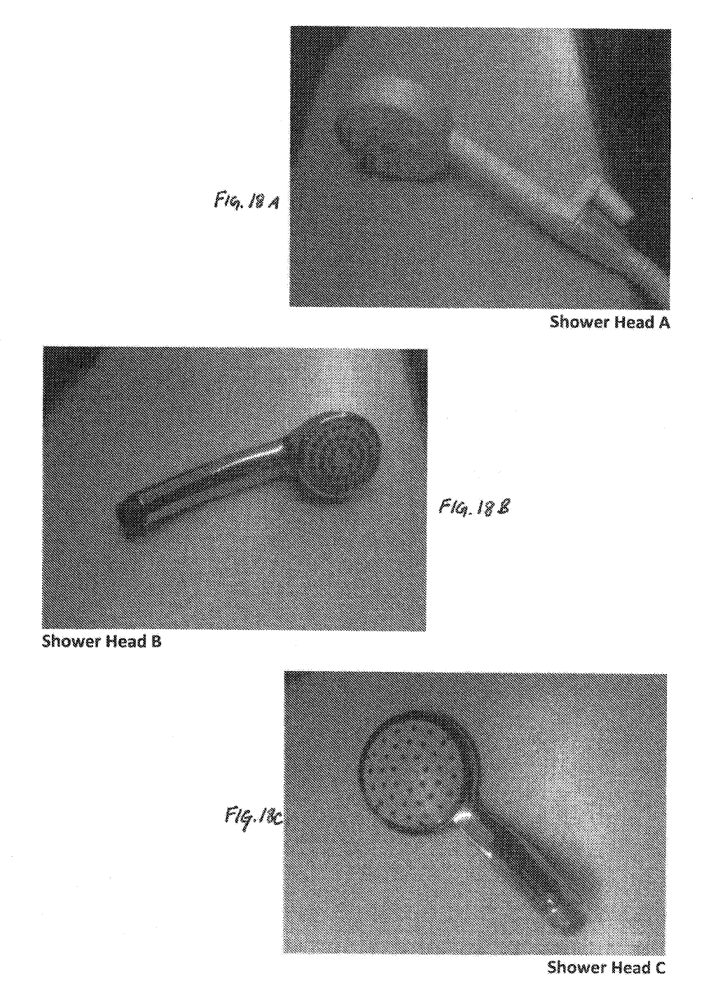

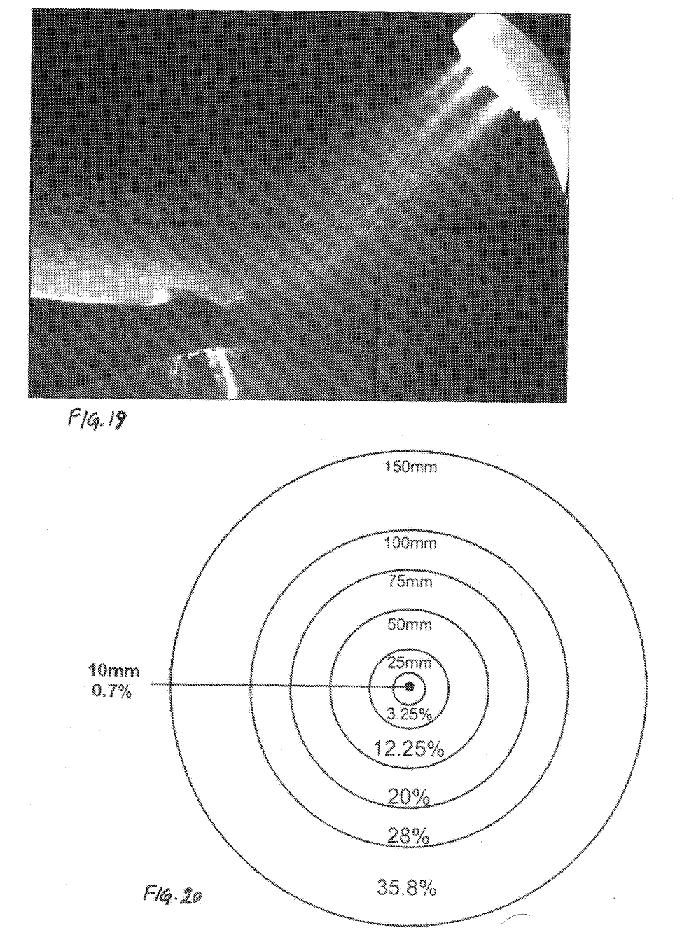

FIGS. 17A, 17B and 17C show variant geometries of the convergent and divergent regions of the droplet formation chamber, with the optimal geometry of FIGS. 1-16 indicated by bold lines;

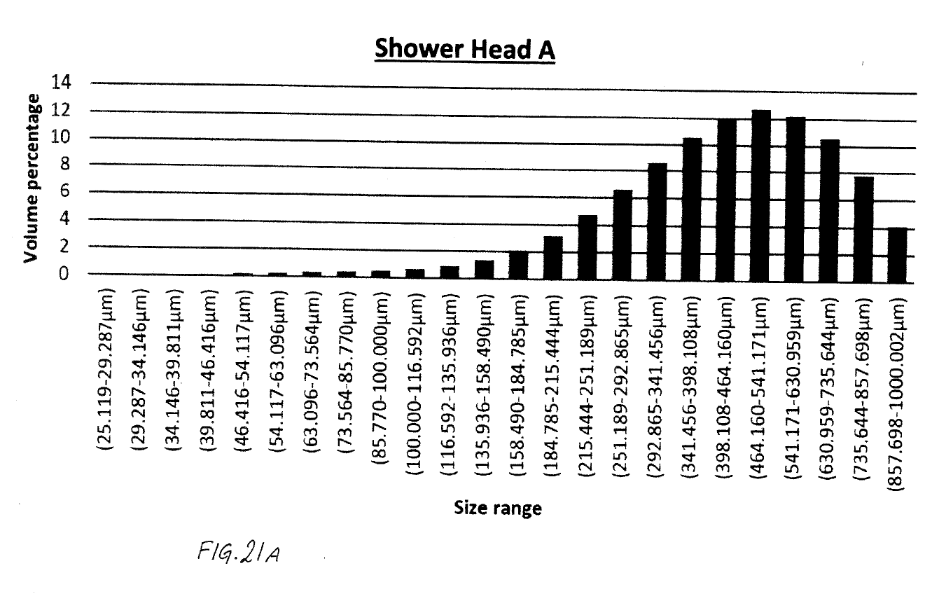

FIGS. 18A-18C are photographs of three shower heads as used in comparative tests, wherein:

FIG. 18A shows Shower Head A, a prototype shower head which is hand-held but otherwise identical to the first shower head, having five droplet generators supplied with air and water as shown in FIGS. 1-16;

FIG. 18B shows Shower Head B, a conventional non-aerating shower head; and

FIG. 18C shows Shower Head C, a conventional aerating shower head;

FIG. 19 is a photograph of Shower Head A in use;

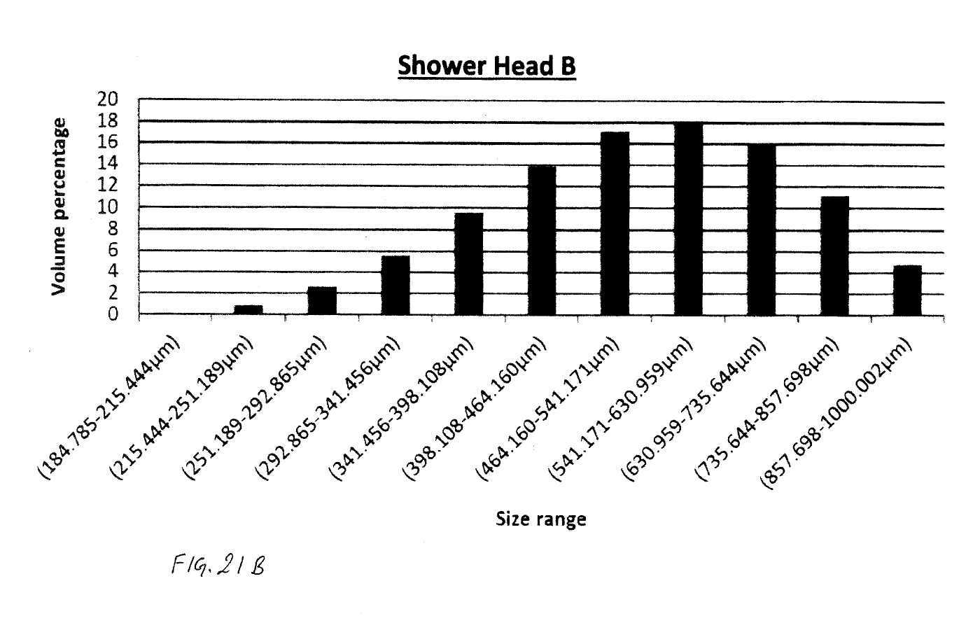

FIG. 20 shows the water distribution pattern of the spray obtained from Shower Head A;

FIGS. 21A, 21B and 21C show the droplet size distributions obtained in the tests, respectively from Shower Head A (FIG. 18A), Shower Head B (FIG. 18B), and Shower Head C (FIG. 18C); and

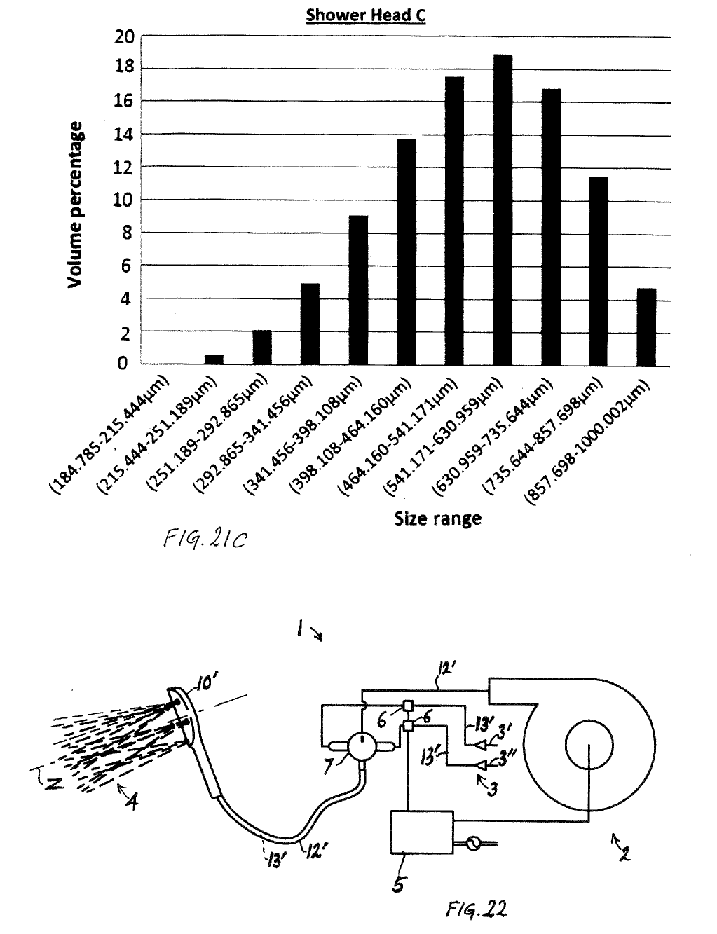

FIG. 22 shows a shower apparatus incorporating a hand held shower head corresponding to Shower Head A.

Reference numerals and letters appearing in more than one of the figures represent the same or corresponding elements in each of them.

Referring to the figures and particularly FIGS. 1-16 and FIG. 22, a shower apparatus 1 (FIG. 22) includes a pressurised air supply means 2 (generally referred to herein as an air pump or blower), a water supply means 3, and a hand held shower head 10′.

The hand held shower head 10′ is the same as Shower Head A as used in the tests further described below, while the first shower head 10 as shown in FIGS. 1-16 is configured for mounting on a wall in a fixed position. In the wall mounted embodiment, the first shower head 10 has a fixed air supply hose or conduit 12 and a separate, fixed water supply hose or conduit 13, while in the hand held embodiment the shower head 10′ has air and water supply conduits 12′, 13′ comprising flexible hoses which are arranged coaxially with the water supply hose 13′ extending inside the air supply hose 12′ which is connected to the end of the handle. In all other respects, including the number, position and internal details of the droplet generators as shown in FIGS. 1-16, shower heads 10 and 10′ are identical. Accordingly in this specification, references to any of the first shower head 10, hand-held shower head 10′ and Shower Head A should be construed mutatis mutandis as references to the others.

Although in the illustrated embodiment the air supply conduit has a relatively smaller diameter than the water supply conduit, the air supply conduit may have a larger diameter in practice. In the tests on Shower Head A described below, the air conduit diameter was 62 mm.

The first shower head 10 includes five identical droplet generators 11, each terminating at a nozzle 22 with an asymmetric tip, and is assembled from a set of interconnected plastics mouldings comprising an upper casing 14, a water distribution plate 15, an air distribution plate 16, and a lower casing 17 which defines apertures which receive five individual mouldings 18 which define the lower parts of the five droplet formation chambers 50 and the nozzles 22, as further described below. In the example shown, each of the mouldings 14-18 is made for example from hard plastics material. Of course, other materials and constructions are possible. For example, the mouldings 18 could alternatively be made from a softer material, e.g. an elastomer, to reduce noise.

The air distribution plate 16 defines the upper part of each droplet formation chamber 50 and the lower part of each air inlet 40, while the water distribution plate 15 defines the water inlets 30 and upper parts of the air inlets 40, as further described below. The water supply conduit 13 communicates with the space formed between the upper region of the upper casing 14 and the water distribution plate 15, which are sealingly connected together so that the water is distributed through the space between them to the water inlets 30.

The air supply conduit 12 communicates with the space formed between the outer region of the upper casing 14, the water distribution plate 15 and the air distribution plate 16, which are sealing connected together. This space defines five plenum chambers 19, each plenum chamber 19 surrounding a respective one of the droplet formation chambers 50 and communicating with the respective air inlet 40, and air supply passages 20 which connect the plenum chambers 19 with the air supply conduit 12.

The upper and lower parts of each droplet formation chamber may be connected together for example by an O-ring seal 21. FIGS. 14, 15 and 16 show a slightly variant construction, identical to that of FIGS. 1-13 except that the upper and lower parts of the chamber are connected without the O-ring seal.

Each droplet generator 11 includes a water inlet 30, an air inlet 40, and a droplet formation chamber 50, also referred to herein simply as a chamber. The droplet formation chamber defines a chamber axis Y extending in a flow direction F and comprising in series arrangement along the chamber axis in the flow direction: an inlet region 51, a throat 52 downstream of the inlet region, a divergent region 53 downstream of the throat, a convergent region 54 downstream of the divergent region, and an outlet 55 at a downstream end 54″ of the convergent region. The convergent region is defined by the interior surface 56 of the wall 57 of the droplet formation chamber, which surrounds the chamber axis Y upstream of an outlet plane P3 normal to the chamber axis Y at the outlet. The water inlet 30 and air inlet 40 both open into the inlet region 51. The air inlet 40 extends around the chamber axis Y and comprises at least one air inlet passage 41 defining a mean airflow path 42. In the illustrated example, six air inlet passages 41 are provided, as further explained below.

The water inlet 30 and air inlet 40 are arranged so that in use, air flowing from the air inlet converges towards water flowing from the water inlet to form droplets of water suspended in air within the droplet formation chamber 50, with the outlet being arranged to deliver said droplets intact from the shower head as a spray of droplets 4 (FIG. 22) in which a user may bathe.

Preferably, the shower head comprises at least three, more preferably from five to seven, optimally exactly five droplet generators 11 as shown, which may be configured so that their respective sprays are emitted in parallel or slightly divergent trajectories or to converge towards a mean central axis Z of the showerhead (FIG. 22). A convergent spray configuration can be achieved either by inclining the axis Y of each droplet formation chamber slightly towards the mean axis Z of the showerhead, or relying on the Coanda effect which may tend to draw the individual sprays together so that they converge towards the mean axis Z. The multiple, overlapping and optionally convergent sprays advantageously mix together droplets of different sizes emitted from different ones of the droplet formation chambers 11, which tend to be separated in each spray with the larger and heavier droplets being more concentrated towards the respective chamber axis Y, so that a more even droplet size distribution is obtained within the compound spray emitted from the showerhead along its mean axis Z.

The droplet formation chamber has an axial length L1 from an upstream end 53′ of the divergent region 53 at the throat 52 to the outlet plane P3.

In a plane P1 normal to the chamber axis Y at the throat 52, the chamber has a section area S1 corresponding to a nominal circle C1 of equal area (i.e. an area equal to that of the section area S1) and diameter D1 lying in the plane P1 and centred on the chamber axis Y.

In a plane P2 normal to the chamber axis Y at a downstream end 53″ of the divergent region 53, the chamber has a section area S2 corresponding to a nominal circle C2 of equal area (i.e. an area equal to that of the section area S2) and diameter D2 lying in the plane P2 and centred on the chamber axis Y.

In the outlet plane P3, the chamber has a section area S3 corresponding to a nominal circle C3 of equal area (i.e. an area equal to the section area S3) and diameter D3 lying in the plane P3 and centred on the chamber axis.

It will be understood that when considered in a plane containing the chamber axis Y, e.g. plane X1 or X5, and as shown in FIGS. 13-16, each of the nominal circles C1, C2, C3 will define two points lying in the straight line defined by the respective plane P1, P2, P3. Where (as shown) the chamber has a circular section normal to its axis Y, each circle will lie along the internal surface 56 of the chamber wall at that plane, as shown in FIGS. 11B and 12B, so that the diameter of each circle corresponds to the actual diameter of the chamber in that plane and extends between the points of intersection of the respective plane P1, P2, P3 with the inner surface 56 of the chamber wall in the plane containing the chamber axis Y. It will be noted that the circle C3 at the outlet plane is represented in FIG. 12B by a dotted line which lies slightly inside the visible boundary of the oblique nozzle tip downstream of the outlet, and coincides with the beginning of the nozzle at the diametrically opposite position.

Although a circular section is preferred, it is possible for the chamber to have a non-circular section, in which case the circles C1, C2, C3 will represent the equivalent section area of a circular chamber.

The divergent region has an axial length L2 and defines in a plane containing the chamber axis Y a divergence angle Ad between the chamber axis and either of a pair of nominal straight lines 56′ extending from C1 to C2 on opposite sides of the chamber axis Y.

The convergent region has an axial length L3 and defines in a plane containing the chamber axis a convergence angle Ac between the chamber axis and either of a pair of nominal straight lines 56″ extending from C2 to C3 on opposite sides of the chamber axis Y.

In the illustrated example, when considered in a plane containing the chamber axis Y, the chamber walls are generally straight from the throat 52 to the widest point of the chamber at plane P2, and from the widest point at P2 to the outlet plane P3, and so the straight lines 56′, 56″ lie along respective portions of the internal surface 56 of the chamber wall. For ease of illustration, in FIG. 16 angles Ac and Ad are indicated only on one side of the chamber axis and are shown relative to reference lines 58 which lie parallel with the chamber axis Y.

Each air inlet passage 41 opens into the inlet region 51 at an air inlet opening 43 and is arranged so that, when considered in a plane containing the chamber axis Y, a straight line 44 extending the mean airflow path 42 at the air inlet opening intersects the chamber axis Y at an impingement angle Ai in a range from 15°-45°.

The geometric parameters of the chamber are further selected so that the ratio L1:D1 is in the range from 2:1 to 5:1, and D2 is not greater than 1.5·D1. The ratio L2:L3 is in the range from 0.6:1.4 to 1.4:0.6. The divergence angle Ad is in the range from 2.5° to 15°.

In tests it is found that each of the above mentioned proportional ranges represents the outer limit beyond which an out-of-range geometric parameter cannot be compensated for by an adjustment to the other value ranges so as to produce an equivalent peformance.

A ratio of L2:L3 in the range from 0.6:1.4 to 1.4:0.6 equates to a range from 0.43:1 to 2.33:1.

For good performance, the ratio L1:D1 is preferably in the range from 2.25:1 to 3.75:1, optimally 3:1 as shown.

For optimal droplet formation, the ratio D1:D2 is most preferably 1:1.18 as shown.

For good performance, L2 and L3 are preferably equal or nearly equal, as in the optimal example illustrated where the ratio L2:L3 is 0.85:1.

For good performance, the impingement angle Ai is preferably in the range from 25° to 45°, optimally about 30° as shown, although a value around the lower end of the preferred range may yield very good peformance. In tests it is found that when the chamber is adapted to define an impingement angle Ai of less than 15°, the inflowing water is not effectively broken into droplets and passes through the chamber as an intact jet, while an impingement angle Ai of more than 45° is found to result in a chaotic flow which also fails to divide the flow into discrete droplets.

Preferably the impingement angle Ai and the length of the inlet region 51 from the water inlet 30 to the throat 52 are selected so that, when considered in a plane containing the chamber axis, a straight line 44 extending the mean airflow path at the air inlet opening intersects the chamber axis Y proximate the throat 52. The point of intersection may be slightly upstream or slightly downstream of the throat. Where the throat has a section area S1 in the range from 33 mm²-95 mm², this point preferably lies within the range from 4 mm upstream of the upstream end 53′ of the divergent region to 1.5 mm downstream of the upstream end of the divergent region. In the illustrated embodiment, the intersection point is about 0.4 mm downstream of the upstream end 53′ of the divergent region.

For good performance, the divergence angle Ad is preferably in the range from 2.5° to about 5° as in the optimal embodiment illustrated. In tests it is found that a divergence angle Ad substantially below 2.5° results in markedly poorer droplet formation in the primary mode with a disproportionate adverse effect on the secondary mode, while a divergence angle substantially greater than 5° results in less efficient operation with reduced spray power and a small reduction in droplet size.

Preferably the convergence angle Ac is similar to the divergence angle Ad. In the illustrated embodiment, the convergence angle Ac is 3.5°, slightly smaller than the divergence angle Ad, which allows the section area S3 of the outlet to be slightly greater than the section area S1 of the throat when the divergent and convergent regions are nearly the same length as shown. The convergence angle Ac influences the proportion of droplets which impact against the chamber walls and hence affects the balance between the primary and secondary modes of droplet formation, and also determines the extent to which noise generated at the throat is reflected from the chamber wall in the convergent region back into the chamber.

The water inlet 30 defines a water flowpath having a minimum total section area S4 in a plane normal to a water inflow direction F (and preferably normal to the chamber axis Y as shown), the section area S4 corresponding to a nominal circle of equal area and diameter D4 in the same plane. Preferably as shown, the water inlet opens into the inlet region at a single water inlet opening 31, and the chamber axis Y extends centrally through the water inlet opening. Further preferably as shown, the water inlet is circular and the diameter D4 is the actual diameter of the water inflow opening 31.

For good droplet formation, the ratio D4:D1 is preferably from 0.26:1 to 0.54:1, optimally 0.4:1 as shown.

The section area S3 and diameter D3 at the outlet is preferably at least equal to the section area S1 and diameter D1 at the throat, to ensure that the spray cone issuing from the outlet is not narrowed and that the secondary mode of droplet formation does not predominate. The ratio D3:D1 is preferably in the range from 0.75:1 to 1.4:1, more preferably from 1:1 to 1.4:1, optimally 1.05:1 as in the illustrated embodiment.

Preferably (when configured as as whole body shower) the shower head includes at least three droplet generators 11, wherein S1 is in the range from 33 mm²-95 mm², and most preferably about 50 mm², which for a circular or near circular section equates to a diameter D1 at the throat of preferably 6.5 mm-11 mm, most preferably about 8 mm as shown in the illustrated embodiment. In tests it is found that a diameter D1 of less than about 6.5 mm requires an excessively powerful air pump while a value of D1 above about 11 mm results in a maximum velocity too low for good droplet formation.

Preferably, where the diameter D1 at the throat is in the range from 6.5 mm-11 mm, the outlet diameter D3 is in the range from 6.5 mm-12 mm, and further preferably the overall length L6 from the upper wall of the air inlet (where the air flows into the inlet from the plenum chamber) to the outlet plane P3 is in the range from about 35 mm to 45 mm, optimally about 40 mm as in the illustrated embodiment.

The overall length L6 represents the total fluid path over which the air and water are accelerated, and hence a reduced length L6 will result in reduced spray power. A substantial reduction in length can be offset by increasing the divergence and convergence angles Ad and Ac, which however reduces the dynamic efficiency of the chamber and so impairs its performance. If the length L6 is substantially increased then a greater proportion of the primary droplets will tend to impact on the chamber walls, so that the secondary droplet formation mode will tend to predominate, resulting in a finer, cooler spray with a reduction in perceived spray power.

For the same reason, the ratio L4:D1 is preferably in the range from 2.5:1 to 5.5:1, optimally 4:1 as shown.

The length L5 is preferably in the range from about 3 mm to 11 mm, optimally 7.5 mm as in the illustrated embodiment. Where the water inlet includes guide surfaces as shown, this advantageously ensures a straighter water jet which also helps to ensure that the desired proportion of larger primary droplets pass through the chamber without impacting on the walls, and so helps to maintain the balance between the primary and secondary modes of droplet formation.

The length L3 of the convergent region is preferably about 13 mm as shown. It is found that a chamber with a convergent region of at least about this length is about 1.5 dBa quieter than an equivalent chamber with a substantially shorter convergent region, for the same airflow, and also produces a spray that is perceived as somewhat more powerful by the user, which allows the use of a relatively less powerful air pump. If a relatively substantially shorter convergent region is used then the convergence angle Ac may be increased to compensate for the reduced chamber length, but with reduced dynamic efficiency. Ceteris paribus, a substantially shorter convergent region is found to result in a more centralised spray with fewer, larger droplets which is perceived by the user as substantially weaker than that of the optimum geometry.

FIGS. 17A, 17B and 17C show the variant geometries of the convergent and divergent regions of the droplet formation chamber as obtained at the limits of the proportional value ranges for L1, L2, L3, D1, D2, the divergence angle Ad, and the preferred range for the ratio D1:D 3, taking as a reference point a single value of D1=8 mm.

For clarity, FIGS. 17A, 17B and 17C show the variant geometries obtained, respectively for values of L2:L3=1:1, L2:L3=0.6:1.4, and L2:L3=1.4:0.6.

The optimal geometry as shown in the illustrated embodiment of FIGS. 1-16 is indicated in bold lines on both sides of the chamber axis Y, with the variant geometries on one side only. The figures illustrate the wall of a chamber with a circular transverse section, wherein values D1 and D2 correspond to the actual diameter of the chamber at planes P1 and P2. Value combinations leading to invalid geometry (e.g. wherein the section area of the convergent region would not reduce towards the outlet, or wherein D2 would lie outside the envelope defined by D2=1.5·D1, represented in the figures by heavy chain lines) are not shown.

It can be seen that many different valid geometries are possible within the stated proportional value ranges, which were established during extensive and iterative testing as the limits for each of the key geometric parameters of the chamber beyond which the desired balance between primary and secondary droplet formation mechanisms can no longer be obtained. To ensure good performance when the geometric parameters of the chamber are modified within their maximum limits, it is preferred to select value combinations within the preferred ranges, which yield an overall shape more closely similar to the optimal case represented by the bold lines and were found during testing to provide a balance of primary and secondary droplet formation modes approaching that of the optimal case. Further advantageously in a handheld shower apparatus, the optimal geometry also yields a relatively short chamber which is compatible with the aspect ratio of a conventional shower handset.

In the optimal, illustrated embodiment, as tested in Shower Head A, the ratio L2:L3 is 0.85:1, represented in FIGS. 17A-C as “ILL.”. The parameter values are as follows:

D1=8.00 mm

D2=9.75 mm

D3=8.25 mm

D4=3 mm

D5=4.4 mm

S5 (annular area at the upstream end of the air inlet)=351 mm²

L1=24 mm

L2=11 mm

L3=13 mm

L4=32.6 mm

L5=7.5 mm

L6=40 mm

Ai=30° (approximate)

Ad=5° (approximate)

Ac=3.5° (approximate)

In this specification, a plane generally means a flat plane, and a chamber region, passageway or flowpath is taken to be “convergent” or “divergent” if its section area (transverse to the flow direction F) progressively decreases or increases, respectively, in the flow direction.

The interior wall surface of each of the serially arranged parts of the droplet formation chamber may be a surface of revolution about the chamber axis, so that the chamber has a circular section, preferably at any point along its length. When considered in a plane containing the chamber axis, the interior wall surface of each part of the chamber may be straight or gradually curved, or (as shown) may combine straight and curved portions so that the chamber sections blend smoothly together. Alternatively the chamber may be faceted along part or all of its length so that it has a polygonal section normal to the flow direction, or it may have a non-circular (e.g. slightly elliptical or egg-shaped) section normal to the flow direction, e.g. so as to help direct the spray towards the mean discharge axis Z of the shower head.

The water and air inlets and other flowpaths defined by the showerhead may similarly have curved or polygonal sections. Preferably however the water inlet has a circular transverse section (interrupted upstream of the water inlet opening by guide surfaces) coaxial with the chamber axis.

The throat defines the transition from the inlet region to the divergent region. The inlet region may be convergent towards the throat, so that the throat may be defined by a line marking the upstream end of the divergent region where the chamber section area or diameter between the inlet and divergent regions is at a minimum. The transition from the convergent, inlet region to the divergent region may be smoothly curved so that the throat is defined at the point of minimum section area or diameter along the chamber axis at the transition. Alternatively, the throat may define a parallel sided region of the chamber which extends for a short distance along the chamber axis and terminates at the beginning of the divergent region.

The wall surface of the chamber defining the inlet region may be straight or smoothly curved so that it converges at a constant (or constantly varying) rate towards the chamber axis at the throat, or alternatively may define one or more curved or angled transitions along the length of the inlet region.

Preferably, the wall surface of the chamber defining each of the divergent and convergent regions is also straight or smoothly curved as shown so as to define along at least most of its length a constant angle (or a continuously and slightly varying tangent angle) relative to the chamber axis, but it may similarly comprise one or more curved or angled transitions along its length (particularly where it transitions into the adjacent region).

Preferably the downstream end of the divergent region is located at the upstream end of the convergent region, so that there is no parallel region between them, although a short parallel region may be provided, for example, to accommodate an O-ring seal 21 as illustrated in the construction shown in FIGS. 1-13, where the seal connects together at the widest point of each chamber the two separate plastics mouldings that form the upper and lower parts of the chambers. A smoothly curved transition between the two regions is found to work well.

The outlet 55 may be located at the outer surface of the shower head, which is the most compact configuration, although it is possible for a further component to extend downstream from the outlet, e.g. in the manner of a short, flaring collar or, as shown in the illustrated embodiment, an asymmetric nozzle 22 from which the spray is emitted. Optionally, the outlet or downstream nozzle may have a discontinuous margin so as to provide a decorative pattern of small secondary droplets which further visually define the spray.

The convergent region 54 may be configured as a fixed part of the droplet formation chamber 50, as in the illustrated embodiment, or alternatively (in whole or in part) as an adjustable nozzle which allows the angle of the jet from each chamber 50 to be altered somewhat so as to alter the shape of the compound spray from the shower head. (Another way of providing such adjustment is for the whole chamber or the whole droplet generator to be angularly adjustable within the shower head so that the convergent region is fixed relative to the other components of that chamber.)

The chamber axis Y is defined either as the mean central axis of the inlet region, throat, divergent region and convergent region (or fixed portion of the convergent region) of the droplet formation chamber in the case where the convergent region (or a portion of the convergent region) is configured as a fixed part of the chamber, or as the mean central axis of the inlet region, throat, and divergent regions of the chamber in the case where the convergent region is configured as a nozzle which is angularly adjustable with respect to that axis. Preferably as shown the chamber axis Y extends in a straight line from the inlet region 51 to the outlet 55 and passes centrally through each of the inlet region, throat, divergent and convergent regions.

The convergent region 54 is defined by the interior surface 56 of the wall of the chamber which surrounds the chamber axis Y upstream of the outlet plane P3 normal to the chamber axis at the outlet.

The wall surface 56 defining the droplet formation chamber is preferably curved about the chamber axis Y and most preferably is a surface of revolution about the chamber axis Y, as shown. In this case, and where the convergent region 54 is formed by a fixed part of the chamber, the chamber upstream of the outlet plane P3 has a circular section and so the outlet 55 is also circular as shown.

In the illustrated embodiment, a fixed nozzle 22 is provided downstream of each outlet. The nozzle is asymmetric, being arranged according to the angle at which the shower head is to be fixed to ensure that water remaining on the shower head will drip from the tip of the nozzle. This helps to prevent limescale staining by ensuring that drops of water do not run back and evaporate from the shower head casing after use. An asymmetric nozzle may also be arranged in a fixed or hand held shower head to influence the direction of the spray issuing from each chamber.

As shown in FIGS. 13-16, the outlet plane P3 is defined at the point where the chamber wall is shortest in the axial direction, i.e where it ceases to extend for a full revolution so as to surround the chamber axis.

If, alternatively, the convergent region includes or consists of an adjustable nozzle (not shown) which can swivel about the chamber axis, then the geometric parameters of the adjustable portion of the droplet formation chamber, including the fixed position of the outlet plane P3 and the section area S3 and diameter D3 of the chamber at the outlet, are defined when the nozzle is adjusted so that the chamber axis Y passes as nearly as possible centrally through it.

Air and Water Inlets

The air inlet 40 extends around the chamber axis Y to substantially surround the water inlet 30 when viewed in the direction of the chamber axis Y (FIG. 11B); which is to say, the air inlet extends at least most of the way around the chamber axis and the water inlet. Most preferably, the air inlet defines an uninterrupted, annular opening 43 which extends for a full 360° of revolution around the chamber axis and water inlet, or where guide surfaces 45 are provided as shown, the air inlet extends downstream of the guide surfaces to define said uninterrupted annular opening. This allows the airstreams exiting each air inlet passage to unite to form a uniform, annular flow which impinges evenly on the stream of water exiting the water inlet so as to form regular sized droplets with minimal turbulence.

Preferably the water inlet opens into the inlet region via a single water inlet opening 31 (i.e. not more than one water inlet opening) to discharge water axially centrally into the droplet formation chamber along the chamber axis Y. This is found to be the optimal configuration for droplet formation and also particularly advantageous in hard water areas because it minimises the effect of limescale formation within the water inlet opening (which is much larger than the individual pinhole sized outlets of a conventional shower rose). Less preferably, it could be arranged to discharge water around the chamber axis within the convergent airflow.

In use, it is found that the illustrated position of the water inlet opening upstream of the point where the converging airflow impinges on the discharged stream of water is a zone of neutral pressure, so that the airflow applies little or no positive or negative pressure and the water can flow freely from the water inlet.

The water inlet opening could be formed integrally with the other parts of the shower head from a hard plastics material as in the illustrated embodiment, or from an elastomeric material, e.g. by co-moulding, to further reduce the effects of limescale formation. Preferably each droplet generator 11 is provided with an individual plenum chamber 19 for supplying air to the air inlet and one or more air supply passages 20 for supplying air from the air supply hose or conduit to the plenum chamber. Preferably as shown, the plenum chamber has a larger section area (defined transverse to the air flow direction, hence as an annular area in the illustrated embodiment) than the air inlet 40, optionally also larger than the air supply passage, so that in use, air flow velocity is lower in the plenum chamber than in the air inlet and optionally also the air supply passage.

Further advantageously, each plenum chamber 19 may extend around the chamber axis Y, so that the air flow is generally radially inward towards the air inlet 40 as shown, which preferably leads radially inwardly with a progressively reducing section area from the plenum chamber to the inlet region 51, as shown. The droplet formation chamber 50 may be arranged (in whole or in part) radially inside the plenum chamber 19 as shown to give a very compact configuration. The low flow velocity in the plenum chamber minimises flow resistance as the airflow changes direction between the air supply conduit 12 and the air inlet 40 and distributes the airflow at equal pressure at all points of the air inlet 40 around the chamber axis. The reduced total flow resistance also makes it possible to minimise the size of the blower.

The or each air inlet passage 41 opens into the inlet region at an air inlet opening 43 which can be considered as an imaginary surface extending within the section area of the air inlet transverse to the airflow direction. In the illustrated embodiment, the air inlet opening 43 forms a surface of revolution about the chamber axis Y.

The mean airflow path 42 is the mean path of the airflow through the or each respective air inlet passage, and when considered in a plane containing the chamber axis Y may be approximated by a line mid-way between the opposite walls of the air inlet passage, as shown in FIG. 16.

When considered in a plane containing the chamber axis Y and the mean airflow path, where the walls of the air inlet are parallel or convergent along the length of the air inlet from the plenum chamber to the inlet region, then the air inlet opening (REF NO, FIG. 16) may be defined as shown as a line normal to the mean airflow path at the boundary between the air inlet and the inlet region where the walls defining the air inlet begin to diverge in the airflow direction. It is possible alternatively for the walls of the air inlet (considered in the same plane) to be somewhat divergent along the length of the air inlet, in which case the air inlet opening is defined in said plane as a line normal to the mean airflow path at the boundary between the air inlet and the inlet region at that point where there is a marked increase in the rate of divergence of the walls defining the air inlet. It will be understood of course that in either case, where the air inlet substantially surrounds the chamber axis, its total section area will decrease (i.e. the air inlet will be convergent) towards the inlet region, in which case the air inlet opening 43 is defined as shown at the point on the mean airflow path 42 where the air inlet 40 has its minimum section area normal to the mean airflow path.

Preferably the air inlet 40 is convergent in the flow direction from the plenum chamber 19 to the inlet region 51, with the convergence or progressive reduction in section area being principally due to the radially inward direction of the air inlet rather than the degree of parallelism or otherwise of its two curved walls when considered in a plane containing the chamber axis.

Preferably, the section area (S5, D5) of the air inlet 40 at its upstream end at which it opens into the plenum chamber 19 is several times greater than its section area at the air inlet opening or openings 43 at which it opens into the inlet region 51. In the illustrated embodiment, the section area S5 of the upstream end of the air inlet is about 150 mm² while the section area S1 at the throat is about 50 mm², giving a ratio S5:S1 of about 7:1. It can be seen that the air inlet curves smoothly and progressively to turn the airflow through an angle of at least 45° from the plenum chamber to the air inlet opening while converging progressively and smoothly towards the inlet region with the section area reaching a minimum at the throat. By turning the mean airflow path 42 through at least 45° along a length of the air inlet passage 41 a very compact configuration is obtained which can be packaged into a showerhead of generally conventional aspect ratio while accelerating the air to the velocity required for primary droplet formation, typically around 15 m/s (metres per second)-40 m/s at the throat.

It will be appreciated that the air inlet and inlet region define together the convergent region of a radially folded Venturi, with the throat and divergent region forming respectively the throat and divergent region of the Venturi, which may be arranged so that airflow velocity increases progressively from a minimum value in the plenum chamber to a maximum at the throat 52, and then progressively decreases along the length of the divergent region 53 before once more progressively increasing through the convergent region 54 towards the outlet 55. It is found however that by arranging the water inlet 40 upstream of the throat 52 and configuring the geometry of the chamber 50 to conform to the proportional values as described above, optimal droplet formation with improved droplet size distribution is obtained with subtle and surprisingly small variations in the flow velocity within the chamber. Even where the chamber 50 is relatively short compared with its diameter, this is obtained by a relatively more subtle and gradual variation in section area along the length of the droplet formation chamber when compared with prior art droplet formation chambers, yielding a distinctive overall shape as best seen in FIGS. 13-16. Further advantageously, the relatively modest increase in velocity at the throat also generates relatively less noise than a higher velocity flow.

Inlet Guide Surfaces

Where the air inlet 40 is generally annular and convergent towards and along the chamber axis Y it is found that the airflow tends to rotate about the chamber axis, forming a vortex as it accelerates through the convergent air inlet 40 to reach a maximum velocity at the throat 52. This causes the larger droplets to impinge on the wall 57 of the chamber, particularly in the convergent region 54, and so strips them out of the airflow. A similar problem is found where the water inlet 30 converges inwardly towards the water inlet opening 31 as shown, so that the stream of water tends to rotate and hence to move towards the walls 57 of the chamber after it leaves the water inlet.

To prevent the air from forming a vortex as it flows into the chamber, the air inlet 40 is divided by a plurality of guide surfaces 45, which in the illustrated embodiment are defined by the sides of fixed, radial vanes 46 as shown, to form a plurality of air inlet passages 41. The air inlet passages 41 converge towards the chamber axis Y substantially without revolution about the chamber axis, so that each air inlet passage 41 defines a mean airflow path 42 extending through the air inlet passage 41 in a plane containing the chamber axis Y.

Advantageously as shown, the water inlet 30 may also be divided by a plurality of guide surfaces 32, defined in the illustrated embodiment by fixed vanes 33, to form a plurality of water inlet passages 34, each of the water inlet passages 34 extending substantially without revolution about the chamber axis Y towards the water inlet opening 31 at which the water inlet opens into the inlet region 51.

The air and water inlet guide surfaces 45, 32 constrain the air or water flowing through the respective inlet to flow in a radial and axial direction and prevent flow in a circumferential direction, i.e. in rotation about the chamber axis Y, so that the air or water enters the inlet region 51 as a generally laminar, straight or converging flow without swirl or rotation. This is found to help in forming a graded primary droplet size distribution inside the droplet formation chamber 50, in which the larger primary droplets tend to remain near the chamber axis Y while the smaller primary droplets are concentrated towards the periphery of the chamber. The smallest primary droplets therefore tend to be stripped out of the flow as they impinge against the wall of the convergent region 54, forming a film which is detached at the periphery of the outlet or nozzle to form the secondary droplets which contribute to the smaller diameter tail of the droplet size distribution and visually define the boundary of the spray.

The air inlet guide surfaces 45 may divide the air inlet 40 into air inlet passages 41 which are entirely separate, so that the guide surfaces 45 of each air inlet passage form respective walls or portions of the wall surrounding each air inlet passage. Alternatively the guide surfaces may extend only part way into the air inlet, so that the passages or portions of the air inlet defined between adjacent ones of the guide surfaces are fluidly connected together between their upstream and downstream ends. In this case the guide surfaces are arranged to extend for a sufficient distance between opposite walls of the air inlet 40 to substantially prevent air from flowing across the guide surfaces in revolution about the chamber axis.

Similarly, the water inlet guide surfaces 32 may be arranged to divide the water inlet into a plurality of entirely separate water inlet passages, or alternatively may extend only part way into the water inlet so that the passages or portions of the water inlet defined between adjacent ones of the guide surfaces are fluidly connected together between their upstream and downstream ends. Again, in this case the guide surfaces are arranged to extend for a sufficient distance between opposite surfaces of the water inlet to substantially prevent water from flowing across the guide surfaces in revolution about the chamber axis Y.

Air and Water Flow Rates

Where the shower head includes at least three droplet generators, and the throat of each droplet formation chamber 50 has a section area 51 in the range from 33 mm²-95 mm², each droplet generator is preferably supplied with water at a flow rate from about 0.7 l/min (litres per minute) to 2.0 l/min. For example, a shower head with 3-7 droplet generators might be supplied with water at a total flow rate of about 3-6 l/m, while a shower head with 5-10 droplet generators might be supplied with water at a total flow rate of about 6-10 l/m.

The impingement angle Ai is found to be particularly important in maintaining a balance between primary and secondary droplet formation mechanisms. However, the ratio of air and water is also significant. In tests it is found that ceteris paribus, if the air:water ratio is too low, the primary droplet formation mode will tend to predominate, resulting in a narrow spray cone which is perceived as weak or insufficient by the user. Conversely, with too high a ratio of air:water the second mode will tend to predominate, resulting in a finer, cooler spray which also delivers a poor shower experience.

Advantageously, for a shower head including at least three droplet generators, the throat of each droplet formation chamber 50 having a section area S1 in the range from 33 mm²-95 mm², the air and water supply means may be arranged to supply pressurised air and water to the droplet formation chambers at an air:water volume ratio from about 30:1 to about 125:1 at air supply pressure when the shower head is supplied with water at a total water flow rate from 3 l/m-9 l/m.

In the optimal example shown, an air flow rate of 1.5 I/s (litres per second) at pump pressure per droplet chamber and a velocity of about 30 m/s (metres per second) at the throat is found to work well, resulting in about 30% of the water by volume forming droplets in the second mode, and 70% by volume issuing from the shower head as primary droplets.

The air supply means may deliver air at a pressure and flow rate of, for example, around 2-5 kPa and 200-500 l/m.

The air and water supply means may be arranged to provide adjustable air and water flow rates and to reduce the ratio of air relative to water with increasing water flow rate, so that the proportionately increased airflow compensates for lower water volumes to deliver a more consistent shower experience across a range of water flow rates. Where the air and water supply means are arranged to supply the shower head with air at a total air flow rate A, and the shower head includes a number n of said droplet generators, wherein n≥3, each droplet generator is preferably supplied with air at a volume flow rate of ((1/n)A)±20%. This is found to provide an even spray pattern.

Tables 1 and 2 show the water and air flow parameters including the pressure, velocity and flow rate measured at each of S1, S2 and S3 in one of the five droplet formation chambers of Shower Head A when the shower head was connected to a variable speed air pump supplying air at a variable flow rate from 4 I/s (litres per second) to 9 l/s and to a water supply set to a total flow rate of 5 l/m (litres per minute), corresponding to 1 l/m for each of the five mixing chambers. Velocity is shown in m/s (metres per second). The “optimal” pump speed was considered to be a typical speed for practical applications using this air pump with a 5 l/m water flow rate. The maximum (Max) pump speed was limited by the capability of the pump. The measured dimensions of the droplet formation chamber are set out in the tables.

Table 3 shows the ratio of air flow by volume at pump pressure relative to water flow by volume as derived from Tables 1 and 2.

TABLE 1
Water flow parameters

| | | |
|---|---|---|
| Whole shower head | 5 | l/m |
| Flow per water inlet | 1 | l/m |
| Flow per water inlet | 0.016667 | l/s |
| Flow per water inlet per second | 16666.67 | mm³ |
| D4 | 3 | mm |
| S4 | 7.0695 | mm² |
| water velocity | 2.357545 | m/s |

TABLE 2
Air flow parameters

| | Low | Optimal |
|---|---|---|
| Air Pump Setting | Speed | Speed |
| Pump Pressure (KPa) | 2.2 | 6.5 |
| Flow at Pump Pressure | 4 | 7 |
| (l/s) * | | |
| Flow per nozzle (5) | 0.8 | 1.5 |
| (l/s) | | |
| Velocity at Pump | 1.6 | |
| (m/s) * | | |
| * through 62 mm ID tube | | |
| (3020 mm²) | | |

| | Diameter | Area | Pressure | Flow, at this | Velocity | Pressure | Flow, at this | Velocity |
|---|---|---|---|---|---|---|---|---|
| | (mm) | (mm²) | (Kpa) | Pressure (l/s) | m/s) | (Kpa) | Pressure (l/s) | (m/s) |
| Throat (S1) | 8 | 50.272 | −0.1 | 0.818181818 | 16.27509982 | −0.25 | 1.5 | 30 |
| Widest | 9.6 | 72.39168 | 0.07 | 0.816809707 | 11.28319866 | 0.23 | 1.5 | 21 |
| point (S2) | | | | | | | | |
| Outlet (S3) | 8.25 | 53.46309 | 0.007 | 0.817317658 | 15.28751146 | 0.03 | 1.5 | 28 |

| | Mid | Max |
|---|---|---|
| Air Pump Setting | Speed | Speed |
| Pump Pressure (KPa) | 9.6 | 10.4 |
| Flow at Pump Pressure | 9 | 9 |
| (l/s) * | | |
| Flow per nozzle (5) | 1.8 | 1.8 |
| (l/s) | | |
| Velocity at Pump | 3.2 | 3.6 |
| (m/s) * | | |
| * through 62 mm ID tube | | |
| (3020 mm²) | | |

| | Diameter | Area | Pressure | Flow, at this | Velocity | Pressure | Flow, at this | Velocity |
|---|---|---|---|---|---|---|---|---|
| | (mm) | (mm²) | (Kpa) | Pressure (l/s) | (m/s) | (Kpa) | Pressure (l/s) | (m/s) |
| Throat (S1) | 8 | 50.272 | −0.32 | 1.976827094 | 39.3226268 | −0.45 | 1.993653941 | 39.65734288 |
| Widest | 9.6 | 72.39168 | 0.3 | 1.96476378 | 27.1407402 | 0.35 | 1.977963601 | 27.32307912 |
| point (S2) | | | | | | | | |
| Outlet (S3) | 8.25 | 53.46309 | 0.06 | 1.969415943 | 36.83692441 | 0.04 | 1.98401421 | 37.10997756 |

TABLE 3
Air flow by volume at pump pressure:Water
flow by volume (5 l/m)

| | Low | Optimal | Mid | Max |
|---|---|---|---|---|
| Air Pump Setting | Speed | Speed | Speed | Speed |
| Air:Water by volume | 48:1 | 90:1 | 108:1 | 108:1 |
| Air flow per mixing | 48 | 90 | 108 | 108 |
| chamber at pump | | | | |
| pressure (l/m) | | | | |
| Air flow total at | 240 | 450 | 540 | 540 |
| pump pressure (l/m) | | | | |

Table 4 shows the results of further experiments carried out on Shower Head A, in an experimental arrangement corresponding to that of Tables 1-3 but using a lower pressure air pump. The shower head was found to produce a satisfactory spray pattern when supplied with air at a somewhat lower flow rate, falling between the flow rates obtained at the Low Speed and Optimal Speed pump settings used in the experiment of Tables 1-3. The table shows what was considered to be the optimal ratio of ratio of air flow by volume at pump pressure relative to water flow by volume for each of a range of water flow rates.

TABLE 4
Air flow by volume at pump pressure:Water flow by volume

| | | | | |
|---|---|---|---|---|
| Water flow total (l/m) | 3 | 4.5 | 6 | 9 |
| Air flow total at | 253 | 263 | 274 | 310 |
| pump pressure (l/m) | | | | |
| Air pump pressure (kPa) | 2.2 | 2.55 | 2.8 | 4.1 |
| Air:Water by volume | 84:1 | 59:1 | 45:1 | 34:1 |

The results obtained from the tests summarised in Tables 1-4 indicate that the novel shower head can be operated to produce optimal results with a ratio of Air flow by volume at pump pressure:Water flow by volume from less than 35:1 at higher water flow rates, up to substantially in excess of 100:1 for lower water flow rates. Further experiments (results not shown) indicate that satisfactory performance may be obtained with lower ratios than those shown in Table 4, and also with higher ratios of 125:1 or more for a low water flow rate of e.g. 3 l/m. However, a lower ratio can be obtained using a relatively economical, less powerful air pump and still provide optimal peformance, as indicated by Table 4, and so is preferred.

It will be noted that in the tests of Table 4, the air flow rate increased with the water flow rate, but at a relatively lesser rate of increase, so that the air:water ratio progressively reduced with increasing water flow. This control methodology advantageously allows the air pump to be operated in a narrower power band (reducing its maximum output specification) while at lower water flow rates, the kinetic energy of the relatively much more voluminous air flow contributes proportionately more to the total kinetic energy delivered by the spray, whereby the user can appreciate the combined force of the air and water as more nearly equivalent to a higher water flow setting.

The tactile effect of the novel shower head when operated in this way can be appreciated from the test user data set out in Table 11 below, which shows how each user experienced the spray from Shower Head A, when set to a water flow rate of 5 l/m (litres per minute), expressed as an equivalent water flow rate from Shower Head B.

Droplet Size Distribution

FIGS. 21A, 21B and 21C show the measured droplet size distributions obtained during tests from Shower Heads A, B and C respectively. Tables 5, 7 and 9 present a statistical analysis of the results, while Tables 6, 8 and 10 show the measured droplet size distribution of the smallest droplets.

Shower Head B and Shower Head C were commercially available, off-the-shelf products of generally conventional design. Each shower head comprised a rose with multiple apertures. In Shower Head B the apertures were pinhole sized, dividing the water into narrow jets without the admixture of air. Shower Head C was of the aerated or “foaming” type, including a passive aspirator or eductor whereby ambient air was drawn by the Venturi effect into the water flow to issue from the apertures of the rose as multiple air bubbles within a continuous aqueous phase.

The measurements were performed by laser diffraction using a Malvern Spraytec® device with a 300 mm lens capable of measuring aerosol sizes from 0.1 μm to 2500 μm. This technique measures the angular intensity of light scattered from a spray as it passes through a laser beam. The recorded scattering pattern is then analysed using an appropriate optical model to yield a size distribution.

The shower heads were set up at a distance of 25 cm from the measurement zone and the laser beam arranged to cross the middle of the spray (the widest part of the flow) to obtain the best representation of the droplet size distribution. The water flows were fixed at approximately around 10 l/m (litres per minute) for Shower Head B, 8 l/m for Shower Head C, and 5 l/m for Shower Head A, corresponding to the typical water flow rate for each shower head in use. Shower Head A was supplied with air from an air pump set at ⅔ of its maximum flow.

The test procedure corresponded to the equipment manufacturer's Standard Operating Procedure for measuring water spray from a spray bottle, based on the following parameters:

Particulate Refractive Index=1.33 (Water)

Dispersant Refractive Index=1.00 (Air)

Particle Density=1.00 (gm/cc) (Water)

Minimum size=0.10 (μm)

Maximum size=2500.00 (μm)

Multiple Scatter=On

A measurement was performed by the system once per second. At least 15 measurements were carried out for each test to ensure a representative picture of the water flow. The following derived parameters were calculated by the system:

Trans (%): Transmitted light intensity

Dv(10) (μm), Dv(50) (μm), Dv(90) (μm): Size at cumulative volume percentage of 10, 50 and 90%

D[4,3] (μm): Mass moment mean diameter

D[3,2] (μm): Sauter mean diameter=d₃₂=dᵥ³/dₛ²

Cv (PPM): Volume concentration (part per million)

GSD (μm): Geometric standard deviation

%<1μ(%), %<5μ(%), %<10μ (%), %<20μ (%): Volume percentage of droplets with a diameter <1, 5, 10 and 20 μm

Surprisingly, although the secondary droplet formation mechanism works by thin film disintegration which in conventional shower heads is known to give rise to droplets in the hazardous, sub-10 micron size range, the novel shower head was found to produce a volume percentage of droplets in the sub-10 micron size range which was only 1/16 of that of Shower Head C and ⅙ of that of Shower Head B, and a zero volume percentage (to 5 decimals) of droplets in the sub-5 micron size range. Since the total water flow rate was substantially lower than for shower heads 1 and 2, this represents a proportionately even lower total number of droplets in the hazardous size range when compared with the conventional shower heads.

TABLE 5
Shower Head A: Derived Parameters

| Trans | Dv (10) | Dv (50) | Dv (90) | D[4, 3] | D[3, 2] | Cv | GSD |
|---|---|---|---|---|---|---|---|
| (Av) % | (Av) μm | (Av) μm | (Av) μm | (Av) μm | (Av) μm | (Av) μm | (Av) |
| 45.905 | 223.455 | 454.313 | 761.568 | 473.637 | 359.128 | 924.113 | 1.5967 |

TABLE 6
Shower Head A: Fine Fraction

| % < 1μ(Av) | % < 5μ(Av) | % < 10μ(Av) | % < 20μ(Av) |
|---|---|---|---|
| 0 | 0 | 0.00185 | 0.00196 |

TABLE 7
Shower Head B: Derived Parameters

| Trans | Dv (10) | Dv (50) | Dv (90) | D[4, 3] | D[3, 2] | Cv | GSD |
|---|---|---|---|---|---|---|---|
| (Av) % | (Av) μm | (Av) μm | (Av) μm | (Av) μm | (Av) μm | (Av) μm | (Av) |
| 83.265 | 346.503 | 541.750 | 790.722 | 556.349 | 500.12 | 303.316 | 1.342 |

TABLE 8
Shower Head B: Fine Fraction

| % < 1μ(Av) | % < 5μ(Av) | % < 10μ(Av) | % < 20μ(Av) |
|---|---|---|---|
| 0 | 0 | 0.01224 | 0.01224 |

TABLE 9
Shower Head C: Derived Parameters

| Trans | Dv(10) | Dv(50) | Dv(90) | D[4, 3] | D[3, 2] | Cv | GSD |
|---|---|---|---|---|---|---|---|
| (Av) % | (Av) μm | (Av) μm | (Av) μm | (Av) μm | (Av) μm | (Av) μm | (Av) |
| 80.511 | 357.737 | 549.450 | 791.042 | 563.066 | 504.187 | 361.764 | 1.3223 |

TABLE 10
Shower Head C: Fine Fraction

| % < 1μ(Av) | % < 5μ(Av) | % < 10μ(Av) | % < 20μ(Av) |
|---|---|---|---|
| 0 | 0 | 0.03694 | 0.03713 |

In use, about 30% of the water supplied to the first shower head may be stripped out of the airflow to form secondary droplets, with the remaining 70% travelling out of the droplet formation chamber as primary droplets. The chamber geometry may be maintained within the preferred value ranges to adjust the ratio of primary:secondary droplets from about 25%:75% to about 35%:65% by volume, although it is possible to arrange the droplet formation chamber so that as much as 50% or more of the water is converted to secondary droplets.

Surprisingly, although the secondary droplets are smaller than the larger primary droplets entrained in the air flowing from the chamber, the test results show that the novel shower head produces a negligible proportion of droplets in the hazardous size range. Advantageously, since the smaller, secondary droplets are generated at the edge of the outlet and nozzle, they are entrained at the outer margin of the expanding body of air leaving the nozzle so that they provide visible definition to the outer boundary of the spray.

It is believed that since the largest primary droplets have the greatest inertia and tend to remain closest to the chamber axis, the smaller primary droplets formed within the chamber are preferentially stripped out by contact with the wall of the convergent region. Although it appears that the primary mode of droplet formation tends to produce a droplet size distribution generally in the desired range, it is believed that the convergent region may therefore help to remove any primary droplets in the hazardous size range while allowing the larger primary droplets to pass intact out of the chamber outlet.

In combination, the divergent and convergent regions thus act as a droplet size filter with a primary droplet formation mechanism (acting inter alia by water column attenuation and surface friction) followed by a secondary droplet formation mechanism (detachment of the water film flowing along the convergent wall) by means of which the smallest droplets are stripped out, recombined, and then reformed into small droplets above the hazardous size range which serve to visually define the spray.

In order to form the desired droplet size distribution, it is found to be important to arrange the water inlet to admit water into the inlet region of the droplet formation chamber upstream of the throat, so that the airstream begins to attenuate the stream of water flowing from the water inlet before reaching its maximum velocity at the throat.

One challenge in reducing water consumption to a minimum is how to deliver sufficient kinetic and heat energy in the spray while distributing the small volume of water over a target area of comparable size to that of a conventional shower. In tests it is found that Shower Head A incorporating the novel chamber geometry overcomes this problem by producing a droplet size distribution in which, relative to the droplet size distribution for a conventional shower head, the peak droplet size is slightly reduced in volume percentage and shifted to a slightly smaller droplet size, and the mean droplet size (at 50% by volume) is shifted to below the peak droplet size to produce an extended tail at the smaller end of the droplet size range.

The majority of the water spray by volume consists of droplets which are on average somewhat smaller than those of a conventional shower head, providing a finer spray which enables the reduced water volume to be evenly distributed from three or more droplet formation chambers over the target area.

The small size of the droplets at the tail of the distribution is below that which would be expected, in a spray of comparable volume but consisting entirely of droplets in this smaller size range, to deliver sufficient kinetic and heat energy to provide an acceptable tactile shower experience. Nevertheless, when mixed with the larger droplets which form the majority of the spray by volume, it is found that these smaller droplets produce a tactile sensation which is indistinguishable from that produced by the larger droplets, and the combined sensory effect is as if the sensation produced by the larger droplets were spread evenly across the entire target area.

Although the small droplets forming the tail of the distribution are concentrated at the margins of the spray from each droplet generator, the overlapping sprays from the multiple droplet generators advantageously re-mix the droplet sizes to provide an even droplet size distribution throughout the compound spray from the shower head.

FIG. 19 shows how Shower Head A produces a spray which is clearly visually defined even at a low water flow rate of 5 l/m, while FIG. 20 shows the results of tests carried out on Shower Head A to determine the spray distribution pattern when the shower head was arranged horizontally at a distance of 250 mm above a flat plane. The plane was divided into annular regions centred on the mean central axis of the spray, each region being identified by its diameter in mm, and the proportion of the spray impinging on each annular region indicated as a percentage. It can be seen that the arrangement of multiple droplet generators produced an even distribution of water over the test plane.

In use it is found that each droplet generator produces a spray with a cone angle of about 15°-30°, optimally about 25°, while the compound spray produced by the five droplet generators leaves the shower head with a combined cone angle of about 10°.

Subjective User Test Data

By balancing the primary and secondary modes of droplet formation it is found that the first shower head can achieve a droplet size distribution resulting in a shower experience which in tests is found to be comparable with that of a conventional, non-aerating shower head operating at a surprisingly higher water flow rate.

Table 11 shows the results of an independent experimental trial involving 20 participants (15 male students and 5 female students) to quantify the experiential effect of Shower Head A by reference to the corresponding effect on the same user of conventional Shower Head B.

TABLE 11
Results of experimental trial

| Gender | Flow (L/min) | Comments |
|---|---|---|
| Male | 13.8 | Less water, higher pressure |
| Male | 12.1 | Difference in stream wideness |
| Male | 8.3 | Less water |
| Male | 12.4 | NA |
| Male | 14.3 | Better sensation |
| Male | 11 | More comfortable |
| Male | 12.5 | NA |
| Male | 13.7 | Nice feeling |
| Male | 14.7 | Stronger pressure but less water |
| Male | 10.3 | Less water, more pressure |
| Male | 9.7 | Spray-like |
| Female | 11.6 | NA |
| Female | 12.5 | Impressed |
| Male | 12.6 | Air feeling |
| Male | 10.7 | NA |
| Male | 11.6 | NA |
| Female | 12.4 | Good feeling |
| Female | 9.0 | Nicer, softer |
| Female | 11.2 | Softer, finer, more comfortable |
| Male | 12.2 | Liked the finer spray |
| Average | 11.83 | |
| Standard Deviation | 1.684011501 | |

Shower Head A and Shower Head B were supported at a convenient height above a water receptacle. The test was carried out at ambient room temperature with water heated to about 38° C. The water temperature was checked before each test.

Shower Head A was operated with the same flow parameters as used for the droplet size distribution tests of FIGS. 21A-C, being supplied with air from an air pump set at ⅔ of its maximum flow rate and water at a total water flow rate of 5 l/m (litres per minute). Shower Head B was supplied with water at a variable flow rate. Each test subject was asked to place one hand in the spray produced by Shower Head A, and then in the spray produced by Shower Head B which was set to a medium flow rate. The test user was allowed to close their eyes if they wished. The flow rate from Shower Head B was then adjusted to a value at which the test user perceived the spray momentum (spray power) from Shower Head B as equivalent to the spray momentum (spray power) from Shower Head A. Once the test user acknowledged a perception of “same spray momentum”, the water flow rate from Shower Head B was recorded by the tester using a 1 l graduated pitcher and a chronometer.

The results show that the spray momentum from Shower Head A delivering a water flow rate of 5 l/m was perceived on average as equivalent to a flow rate of 11.83 l/m from the conventional Shower Head B (237% that of Shower Head A) at a standard deviation of 1.684.

Referring to FIG. 22, the pressurised air supply means 2 may comprise a blower driven by an electric motor, optionally with an electric or other heating means for heating the air before it is delivered to the shower head. Alternatively the air could be heated via a fluid/fluid heat exchanger, e.g. using the hot water supply as the heat source. Optionally, the air pump may be driven by a DC electric motor which is found to be quieter than the AC equivalent, although of course an AC motor could also be used. The water supply means may comprise a hose or other fluid connection to a larger water supply system (e.g. in a domestic or commercial building, a recreational vehicle or a boat or ship) including a storage tank or incoming utility supply, typically with a heating means for heating the water supply before it is delivered to the shower head. The heating means may heat water for other outlets in a larger water supply system, or may be dedicated to the shower apparatus.

It is found that 99% of users in a temperate climate will shower in water at a temperature of 37 deg.C.-42 deg.C. Preferably therefore for applications in a temperate climate the water supply means is arranged to heat the water to a temperature of around 38.5 deg.C. to 43.5 deg.C. to allow about a 1.5 deg.C. temperature reduction due to heat loss from the droplets along their trajectory from the showerhead to the point of impact with the user's body.

Alternatively or additionally to the user controls, the water flow rate to the shower head or each droplet generator may be controlled by an automatic limit device such as an elastomeric ring which is deformed by the supply pressure to vary the section area of the water flowpath as known in the art.

The water and air supply means may be configured to adjust the total air and water flow rate in various different ways. The ratio of air to water may be fixed or variable, either by the user or as a function of the air or water flow rate. For example, the ratio of air to water may increase or decrease with increasing water flow rate so as to maintain an optimal ratio, for example, as set out in Table 4. The air flow rate may be controlled by any suitable motor control means 5 as known in the art for regulating the motor speed of the blower, e.g. responsive to water flow sensors 6 in the hot and cold water supply lines 3′, 3″.

The water temperature and flow rate to the shower head may be controlled by a valve such as a mixer valve 7 which is adjusted by the user, either directly or indirectly, by means of a control such as a rotary knob or a digital selector. In this case the motor control means may be adjusted by the same user control. This can be accomplished for example by incorporating in the motor control means a potentiometer or other suitable component which is operated by the same user control, for example, by mounting it on a common spindle connecting a rotary control knob to a rotary valve or by connecting it via suitable ratio gearing to such a spindle, in which case the gear ratio may be arranged to vary the ratio of air to water with increasing water flow rate. Alternatively the motor control means may include a sensor 6 which is arranged as known in the art to sense the water flow rate. In yet further alternative control strategies, the user may directly control the air flow rate with the water flow rate being controlled by air flow sensor input.

The novel shower apparatus may be configured to resemble a conventional electric shower, wherein the water heating means comprises one or more conventional immersion heating elements within an insulated casing which is installed in the shower compartment. A rotary power selector knob may be provided for selectively energising the elements to vary the heating energy, with the flow being controlled by a rotary flow control knob which is adjusted by the user to obtain (for any given power setting) fine control of the water output temperature. In such an arrangement, the air blower may be arranged either inside or outside the insulated casing, but conveniently inside so as to recycle air from within the shower enclosure, and the motor control means may be controlled by the rotary flow control knob and/or the power selector knob and/or additional user controls.

In other arrangements, the desired water temperature may be regulated by a mechanically or electrically controlled valve assembly, e.g. a thermostatic mixer valve, which may be mounted inside the shower compartment and controlled mechanically via a rotary knob or other temperature control, or may be mounted outside the shower compartment and controlled electrically responsive to a signal from a temperature selector inside the shower compartment. The latter arrangement may be configured to resemble a conventional so-called “digital shower” with a display screen for indicating the selected temperature. The water flow rate may be controlled directly by a user operable valve or indirectly by a user control which sends a signal to the valve assembly. The motor controller may be controlled by a sensor responsive to water flow rate or directly by the user input to the electrical control system.

In one possible arrangement, the shower hose may be connected within the shower enclosure to a fixture resembling a conventional shower valve manifold with a central horizontal body on which the user controls are mounted, with the central region of the body being adapted to form a housing which contains the air pump and the shower head optionally being mounted on a fixed riser or on a hose depending from the air pump housing.

In yet further alternative configurations, a small water storage tank may be provided for feeding water to the shower head under gravity pressure or under pressure from the air blower (which may match water pressure to air pressure) or a separate water pump, which provides yet further possibilities for controlling the water flow rate responsive to the air flow rate. It is also possible to provide the user with individual controls whereby the air flow rate and water flow rate may be independently controlled.

The novel shower head may be hand held or mounted on a wall, bowl or basin, or other supporting structure. It may be adapted for bathing the whole body or a specific part of the body such as, for example, the feet or the perineal area, with the number of droplet generators being selected to suit the particular application. For example, a single droplet generator might be used to provide a small, focused spray, or up to 10 or more droplet generators could be used for a wide area spray, arranged in a circular pattern or in a straight line, e.g. along a supporting bar or rod, or in any other desired configuration. In this specification, the term “shower head” is construed accordingly to include any apparatus, whether fixed, hand-held or otherwise, from which a spray of water issues in which a use may bathe the whole or part of their body. Advantageously, the increased spray power provided by the pressurised airflow when compared with a conventional shower may provide more rapid cleansing, so that the time required for showering is reduced.

In summary, a shower head comprises one or more droplet formation chambers, each chamber being supplied with water and pressurised air which divides the water into droplets suspended in the airflow. In one aspect, the geometric parameters of the droplet formation chamber may be selected to maintain a balance between primary and secondary droplet formation modes wherein a proportion of the primary droplets formed within the chamber are stripped out of the airflow by impact with the chamber walls and re-entrained as secondary droplets formed by thin film disintegration. In another aspect, the air inlet into the droplet formation chamber may be provided with guide surfaces which maintain a parallel axial airflow through the chamber.

In less preferred embodiments, the novel guide surfaces may be used in a droplet formation chamber which may not necessarily conform to the geometric values described herein, and including where the air inlet is not necessarily annular, so as to improve the droplet formation performance of the chamber by suppressing vorticial air flow and so reducing the volume percentage of water which wets the chamber walls. Similarly, although again less preferably, the novel chamber with geometric parameters falling within the described proportional ranges may be used without guide surfaces.

Many further adaptations are possible within the scope of the claims.

In the claims, reference signs (numerals or letters) in parentheses are provided only for ease of understanding and should not be construed as limiting features.

1. A shower head (10, 10′) for use in bathing, including at least one droplet generator (11), the droplet generator including:
a water inlet (30),
an air inlet (40), and
a droplet formation chamber (50);
the droplet formation chamber defining a chamber axis (Y) extending in a flow direction (F) and comprising in series arrangement along the chamber axis in the flow direction:
an inlet region (51),
a throat (52) downstream of the inlet region,
a divergent region (53) of progressively increasing section area downstream of the throat,
a convergent region (54) of progressively reducing section area downstream of the divergent region, and
an outlet (55) at a downstream end of the convergent region, the convergent region being defined by a wall (57) which surrounds the chamber axis upstream of an outlet plane (P3) normal to the chamber axis at the outlet;
the water inlet and air inlet both opening into the inlet region;
the air inlet extending around the chamber axis and comprising at least one air inlet passage (41) defining a mean airflow path (42), the air inlet passage opening into the inlet region at an air inlet opening (43);
the water inlet and air inlet being arranged so that in use, air flowing from the air inlet converges towards water flowing from the water inlet to form droplets of water suspended in air within the droplet formation chamber;
the outlet being arranged to deliver said droplets intact from the shower head as a spray of droplets in which a user may bathe;
the droplet formation chamber having:
a section area S1 normal to the chamber axis at the throat;
a section area S2 normal to the chamber axis at a downstream end of the divergent region;
an axial length L1 from an upstream end of the divergent region at the throat to the outlet plane (P3);
in a plane (P1) normal to the chamber axis at the throat, a section area S1 corresponding to a nominal circle C1 of equal area and diameter D1 centred on the chamber axis;
in a plane (P2) normal to the chamber axis at a downstream end of the divergent region, a section area S2 corresponding to a nominal circle C2 of equal area and diameter D2 centred on the chamber axis;
in the outlet plane (P3), a section area S3 corresponding to a nominal circle C3 of equal area and diameter D3 centred on the chamber axis;
the divergent region having an axial length L2 and defining in a plane containing the chamber axis a divergence angle Ad between the chamber axis and either of a pair of nominal straight lines (56′) extending from C1 to C2 on opposite sides of the chamber axis;
the convergent region having an axial length L3 and defining in a plane containing the chamber axis a convergence angle Ac between the chamber axis and either of a pair of nominal straight lines (56″) extending from C2 to C3 on opposite sides of the chamber axis;
characterised in that:
when considered in a plane containing the chamber axis, a straight line (44) extending the mean airflow path at the air inlet opening intersects the chamber axis at an impingement angle Ai in a range from 15°-45°;
the ratio L1:D1 is in the range from 2:1 to 5:1;
D2 is not greater than 1.5·D1;
the ratio L2:L3 is in the range from 0.6:1.4 to 1.4:0.6; and
the divergence angle Ad is in the range from 2.5° to 15°.

2. A shower head according to claim 1, wherein the ratio L1:D1 is from 2.25:1 to 3.75:1.

3. A shower head according to claim 1, wherein the divergence angle Ad is in the range from 2.5° to 5°.

4. A shower head according to claim 1, wherein the ratio D3:D1 is in the range from 1:1 to 1.4:1.

5. A shower head according to claim 1, wherein the water inlet (30) defines a water flowpath having a minimum total section area S4 corresponding to a circle of equal section area and diameter D4 normal to a water inflow direction (F); and the ratio D4:D1 is in the range from 0.26:1 to 0.54:1.

6. A shower head according to claim 1 and including at least three droplet generators, wherein S1 is in the range from 33 mm²−95 mm².

7. A shower head according to claim 1, wherein the water inlet opens into the inlet region at a single water inlet opening (31) and the chamber axis extends centrally through the water inlet opening.

8. A shower head according to claim 1, wherein the air inlet is divided by a plurality of guide surfaces (45) to form a plurality of said air inlet passages (41), and the air inlet passages converge towards the chamber axis substantially without revolution about the chamber axis, so that each air inlet passage defines a said mean airflow path (42) extending through the air inlet passage in a plane containing the chamber axis.

9. A shower head according to claim 1, wherein, when considered in a plane containing the chamber axis, the mean airflow path (42) turns through at least 45° along a length of the air inlet passage.

10. A shower head (10, 10′) for use in bathing, including at least one droplet generator (11), the droplet generator including:
a water inlet (30),
an air inlet (40), and
a droplet formation chamber (50);
the droplet formation chamber defining a chamber axis (Y) extending in a flow direction (F) and comprising in series arrangement along the chamber axis in the flow direction:
an inlet region (51),
a throat (52) downstream of the inlet region,
a divergent region (53) of progressively increasing section area downstream of the throat,
a convergent region (54) of progressively reducing section area downstream of the divergent region, and
an outlet (55) at a downstream end of the convergent region;
the water inlet and air inlet both opening into the inlet region;
the air inlet extending around the chamber axis;
the water inlet and air inlet being arranged so that in use, air flowing from the air inlet converges towards water flowing from the water inlet to form droplets of water suspended in air within the droplet formation chamber,
the outlet being arranged to deliver said droplets intact from the shower head as a spray of droplets in which a user may bathe;
wherein the air inlet is divided by a plurality of guide surfaces (45) to form a plurality of air inlet passages (41), and the air inlet passages converge towards the chamber axis substantially without revolution about the chamber axis, so that each air inlet passage defines a mean airflow path (42) extending through the air inlet passage in a plane containing the chamber axis.

11. A shower head according to claim 10, wherein each air inlet passage opens into the inlet region at an air inlet opening (43), and when considered in a plane containing the chamber axis, a straight line (44) extending the mean airflow path at the air inlet opening intersects the chamber axis at an impingement angle Ai in a range from 15°-45°.

12. A shower head according to claim 10, wherein the water inlet is divided by a plurality of guide surfaces (32) to form a plurality of water inlet passages (34), and each of the water inlet passages extends substantially without revolution about the chamber axis towards a water inlet opening (31) at which the water inlet opens into the inlet region.

13. A shower apparatus (1) comprising a pressurised air supply means (2), a water supply means (3), and a shower head (10, 10′) in accordance with claim 1 or claim 10;
wherein the shower head includes at least three said droplet generators (11), and the throat of each droplet formation chamber has a section area S1 in the range from 33 mm°-95 mm²;
and each droplet generator is supplied with water at a flow rate from 0.7 l/minute to 2.0 l/minute.

14. A shower apparatus (1) comprising a pressurised air supply means (2), a water supply means (3), and a shower head (10, 10′) in accordance with claim 1 or claim 10;
wherein the shower head includes at least three said droplet generators (11), and the throat of each droplet formation chamber has a section area S1 in the range from 33 mm²-95 mm²;
and the air and water supply means are arranged to supply pressurised air and water to the droplet formation chambers at an air:water volume ratio from 30:1 to 125:1 at air supply pressure when the shower head is supplied with water at a total water flow rate from 3 l/minute-9 l/minute.

15. A shower apparatus according to claim 14, wherein the air and water supply means are arranged to provide adjustable air and water flow rates and to reduce the ratio of air relative to water with increasing water flow rate.
